(19) United States
(12) Patent Application Publication
(10) Pub. No.: US 2012/0118117 A1
(43) Pub. Date: May 17, 2012

(54) Multi-functional guide table and workpiece support

(76) Inventor: Dino Makropoulos, Edison, NJ (US)

(21) Appl. No.: 13/134,001

(22) Filed: May 24, 2011

Related U.S. Application Data
(60) Provisional application No. 61/347,818, filed on May 24, 2010.

(51) Int. Cl. B26D 1/00

(52) U.S. Cl. 83/13; 83/651

(57) ABSTRACT

A multi-functional guide table and workpiece support system comprising modular components that may be assembled and interchanged for particular purposes.

### FIELD

The present invention is related generally to the field of work-piece support and milling tables. More particularly, the present invention involves systems and methods that enable accurate holding and placement of a work-piece and for the guiding of cutting/milling tools.

### BRIEF DESCRIPTION OF THE DRAWINGS

Embodiments are illustrated by way of example and not by way of limitation in the figures of the accompanying drawings, in which like references may indicate similar elements throughout the various figures unless otherwise specified.

FIG. 1 is a perspective view of a guide table 500, in accordance with an embodiment;

FIGS. 2a and 2b are perspective and end views, respectively, of a sliding modular extrusion (SME) 610, in accordance with an embodiment;

FIGS. 3a and 3b are perspective and end views, respectively, of a back-to-back extrusion (B2B) 630, in accordance with an embodiment;

FIGS. 4a and 4b are perspective and end views, respectively, of a super sliding modular extrusion (SSME) 640 in accordance with an embodiment;

FIGS. 5a and 5b are perspective and end views, respectively, of a connector 660 comprising a substantially I-shaped elongated member in accordance with an embodiment;

FIG. 6 is a cross-sectional view of a SME 610 and a connector 660 in accordance with an embodiment;

FIGS. 7 and 8 are perspective views, FIG. 9a is an exploded perspective view, and FIG. 9b is a cross-sectional view of an embodiment of a guide assembly;

FIGS. 10 and 11 are perspective views, FIG. 12a is an exploded perspective view, and FIG. 12b is a cross-sectional view of another embodiment of a guide assembly;

FIGS. 13a and 13b are perspective and end views, respectively, of a unitary guide assembly referred herein as a guide track;

FIGS. 14a, 14b, and 14c are top, bottom, and exploded perspective views, respectfully, of a circular saw attachment assembly 1600 for use with a conventional portable, handheld circular saw;

FIG. 15 shows an attachment assembly and guide plate in accordance with an embodiment;

FIGS. 16 and 17 are side and exploded views, respectively, of the guide table 500 of the embodiment;

FIG. 18a is a perspective view of the four legs 700, in accordance with an embodiment;

FIG. 18b is a perspective partially disassembled view of the leg including an SME, connector, and a foot;

FIG. 19a is a perspective view of two frame end connectors 606, in accordance with an embodiment;

FIG. 19b is a perspective view of an SSME 610 being received over a connector 660 that is coupled to one of the two frame end connectors 606, in accordance with an embodiment;

FIG. 20 is a perspective view of two frame end connectors 606 coupled together with two SSME 640 forming the frame 600, in accordance with an embodiment;

FIG. 21 is a partial perspective view of an assembly wherein the leg 700 comprises an SME 610 being received onto a connector 660 that is coupled to the frame end connector 606, in accordance with an embodiment;

FIG. 22 is a perspective view of the frame 600 of FIG. 20 coupled to four SMEs 610 forming the legs;

FIG. 23a is a fence 780 that comprises one or more sliding squaring stops 782 that couple to the SME 610 with connector 660, in accordance with an embodiment;

FIG. 24a is a perspective view of a slide bar stop 855 that may couple to the slide bar 1074 of a guide track 810;

FIGS. 24b-24c are perspective views of a second stop 850 and third stop 860 comprising a slide bar 1074 and a connector 660 operable to be coupled to the central channel of the SMEs 610, in accordance with an embodiment;

FIG. 25 shows a gap formed between the two modified connectors;

FIG. 26a shows a substantially zero clearance support for the saw blade therebetween;

FIG. 26b shows the leading edges of the first and second stops provide a fence or support to rest a workpiece against during working:

FIG. 27 is a perspective view of the third stop 870 as coupled to a SME 610, in accordance with an embodiment.

FIG. 28a is a perspective view of the slide bar stop 855 as coupled to a SME 610, in accordance with an embodiment;

FIG. 28b is a perspective view of the slide bar stop 855 as coupled to a SME 610 and used as a squaring stop to support a workpiece 99 on two sides, in accordance with an embodiment;

FIG. 29 is a perspective view of the third stop 860 as coupled to a SME 610, in accordance with an embodiment;

FIG. 30 is a perspective view of the second stop 850 as coupled to a SME 610, in accordance with an embodiment;

FIG. 31 is a perspective view of the top of the frame 600 and central SSME 640h with the sliding brackets 693 and 792 shown without a connecting SME 610, in accordance with an embodiment;

FIGS. 32a and 32b are perspective views of the bridge assembly; in accordance with an embodiment;

FIG. 33 is a top perspective view of a workpiece 99 engaged with the guide table 500, in accordance with an embodiment; and

FIGS. 34a and 34b are top and bottom views, respectively, of the guide table 500, in accordance with an embodiment.

### DETAILED DESCRIPTION

In the following description, embodiments of apparatus and methods will be disclosed. For purposes of explanation, specific numbers, materials, and/or configurations are set forth in order to provide a thorough understanding of the embodiments. However, it will also be apparent to those skilled in the art that the embodiments may be practiced without one or more of the specific details, or with other approaches, materials, components, etc. In other instances, well-known structures, materials, and/or operations are not shown and/or described in detail to avoid obscuring the embodiments. Accordingly, in some instances, features are omitted and/or simplified in order to not obscure the disclosed embodiments. Furthermore, it is understood that the embodiments shown in the figures are illustrative representations and are not necessarily drawn to scale.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Reference throughout this specification to a guide assembly 10, 1000 and to a guide track 810 refers to tool guides similar to the multi-functional woodworking guide as disclosed in U.S. Pat. No. 7,621,206, issued on Nov. 24, 2009, incorporated herein in it's entirety by reference. Reference throughout this specification to a bridge assembly refers to an improvement over embodiments of a guide control unit and a tool guide as disclosed in U.S. Pat. No. 7,201,192, issued on Apr. 10, 2007, incorporated herein in it's entirety by reference.

Reference throughout this specification to a workpiece refers to any material that is to be supported by the guide table in order to be worked by a hand tool. By way of example, but not limited thereto, a workpiece may refer to a sheet of plywood, a length of dimensional lumber, and a length of extruded acrylic plank.

Reference will now be made to embodiments illustrated in the drawings and specific language which will be used to describe the same. It will nevertheless be understood that no limitation of the scope of the invention is thereby intended. Alterations and further modifications of the illustrated embodiments and further applications of the principles of the invention, as would normally occur to one skilled in the art to which the invention relates, are also within the scope of the invention.

Embodiments herein provide a guide table for guiding interchangeable handheld tools. The guide table is modular and therefore easily extendable in length and width, as well as height. In accordance with embodiments, the guide table enables a cut line to be set without the necessity for offset measurements, such as those required by a circular saw that has a base plate that offsets a cutting blade from a base plate edge.

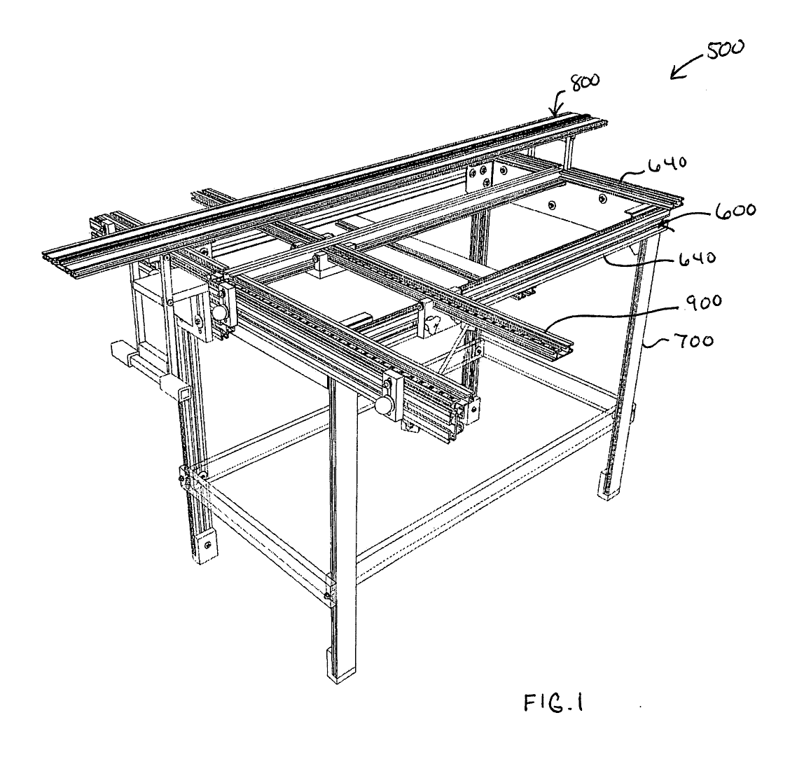

FIG. 1 is a perspective view of a guide table 500, in accordance with an embodiment. The guide table 500 comprises a plurality of legs 700, a frame 600, a bridge assembly 800, and a plurality of stops. As will be provided below, the guide table 500 is comprised of many modular components that allow for customization of width, length and height. Also as provided below, the guide table 500 is operable to provide many configurations for securing a workpiece against the stops and the bridge assembly 800.

Embodiments of modular components and assemblies made therefrom are presented below by way of example and not limited thereto.

Sliding Modular Extrusion (SME)

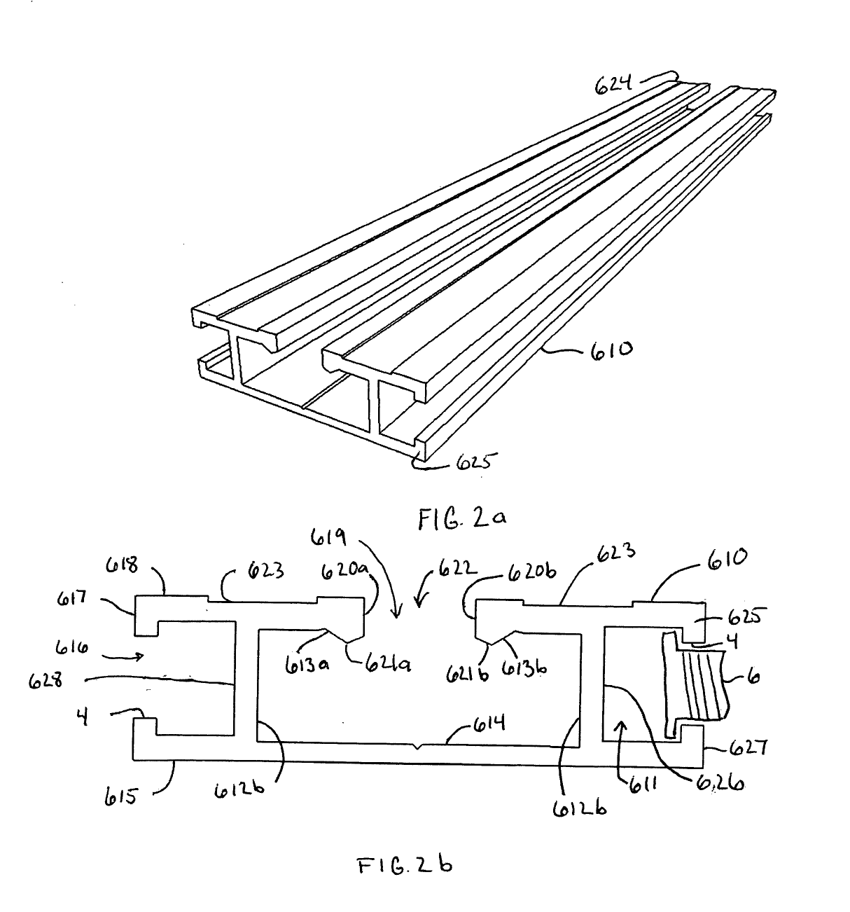

FIGS. 2a and 2b are perspective and end views, respectively, of a sliding modular extrusion (SME) 610, in accordance with an embodiment. The SME 610 comprises an elongated member made from suitable materials, such as, but not limited to, aluminum, plastic, composite, metal and metal alloy.

The SME 610 includes a first working surface 618, a second working surface 615, a front edge 625, a rear edge 624, a first perimeter side edge 617 and a second perimeter side edge 627. The first working surface 618 of SME 610 includes an SME central channel 619 that is centrally (axially) positioned extending from the front edge 625 to the rear edge 624, along a longitudinal length of the SME 610. The SME central channel 619 includes a pair of V-notched grooves 613a, 613b, a plurality of vertically aligned, interior sidewall surfaces 620a, 620b, 612a and 612b and an interior base wall surface 614 defining a T-shape. The peak-shaped ribs 621a, 621b defining the V-notched grooves 613a, 613b are operable for cooperative engagement with elements, such as, but not limited to, those on the connector 660, as shown in FIG. 6, for self-centering of the connector 660 within the SME central channel 619 (to be discussed hereinafter). The first working surface 618 of the SME 610 optionally includes a plurality of relief elements 623 suitable for the deposit of, such as, but not limited to, sawdust, metal filings and the like from working the workpiece, in order to not create, among other things, a friction problem.

The first perimeter side edge 617 includes a centrally positioned first sidetrack 628 extending from the front edge 625 to the rear edge 624, along the longitudinal length of SME 610. The first sidetrack 628 includes a first tracking channel 616 that defines a square-shaped interior with lips 4 defining an opening along the length of the first perimeter side edge 617. The second perimeter edge side 627 also includes a second sidetrack 626 extending from the front edge 625 to the rear edge 624, along the longitudinal length of guide plate SME 610. The second sidetrack 626 also includes a tracking channel 611 that defines a square-shaped interior with an opening running the length of the second perimeter side edge 627. The square-shaped interior is operable to slidingly receive a fastener, such as, but not limited to, a head of a bolt 6, therein which is captured by the lips 4.

Back-to-Back (B2B) Extrusion

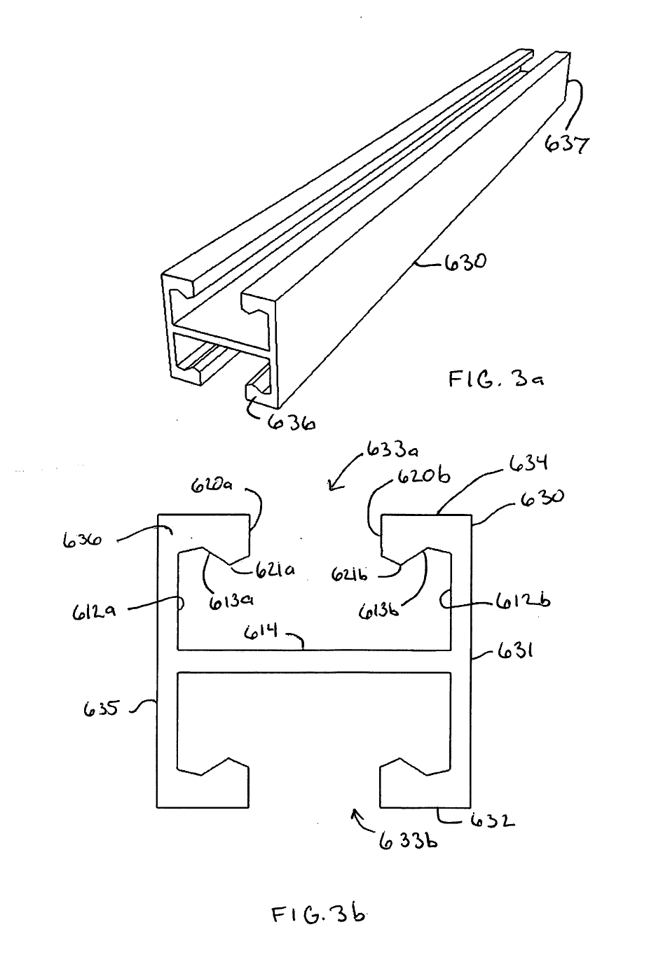

FIGS. 3a and 3b are perspective and end views, respectively, of a back-to-back extrusion (B2B) 630, in accordance with an embodiment. The B2B 630 comprises an elongated member made from suitable materials, such as, but not limited to, aluminum, plastic, composite, metal and metal alloy.

The B2B 630 includes a first working surface 634, a second working surface 632, a front edge 636, a rear edge 637, a first perimeter side edge 635 and a second perimeter side edge 631. The first working surface 634 of B2B 630 includes a B2B first central channel 633a that is centrally (axially) positioned extending from the front edge 636 to the rear edge 637, along a longitudinal length of the B2B 630. The B2B first central channel 633 includes a pair of V-notched grooves 613a, 613b, a plurality of vertically aligned, interior sidewall surfaces 620a, 620b, 612a and 612b and an interior base wall surface 614 defining a T-shape. The peak-shaped ribs 621a, 621b defining the V-notched grooves 613a,b are operable for cooperative engagement with elements, such as, but not limited to, those on the connector 660 for self-centering of the connector 660 within the B2B first and second central channels 633a,b (to be discussed hereinafter).

The second working surface 615 of B2B 630 includes a B2B second central channel 633b that is centrally (axially) positioned extending from the front edge 636 to the rear edge 637, along a longitudinal length of the B2B 630 and adjacent to and symmetrical with the B2B first central channel 633a along axis Z. As with the B2B first central channel 622a, the B2B second central channel 633b includes a pair of V-notched grooves 613a, 613b, a plurality of vertically aligned, interior sidewall surfaces 620a, 620b, 612a and 612b and an interior base wall surface 11034 defining a T-shape. The peak-shaped ribs 621a, 621b defining the V-notched grooves 613a,b are operable for cooperative engagement with elements, such as, but not limited to, those on the connector 660 for self-centering of the connector 660 within the B2B first central channel 622a and the B2B second central channel 633b (to be discussed hereinafter).

Super Sliding Modular Extrusion (SSME)

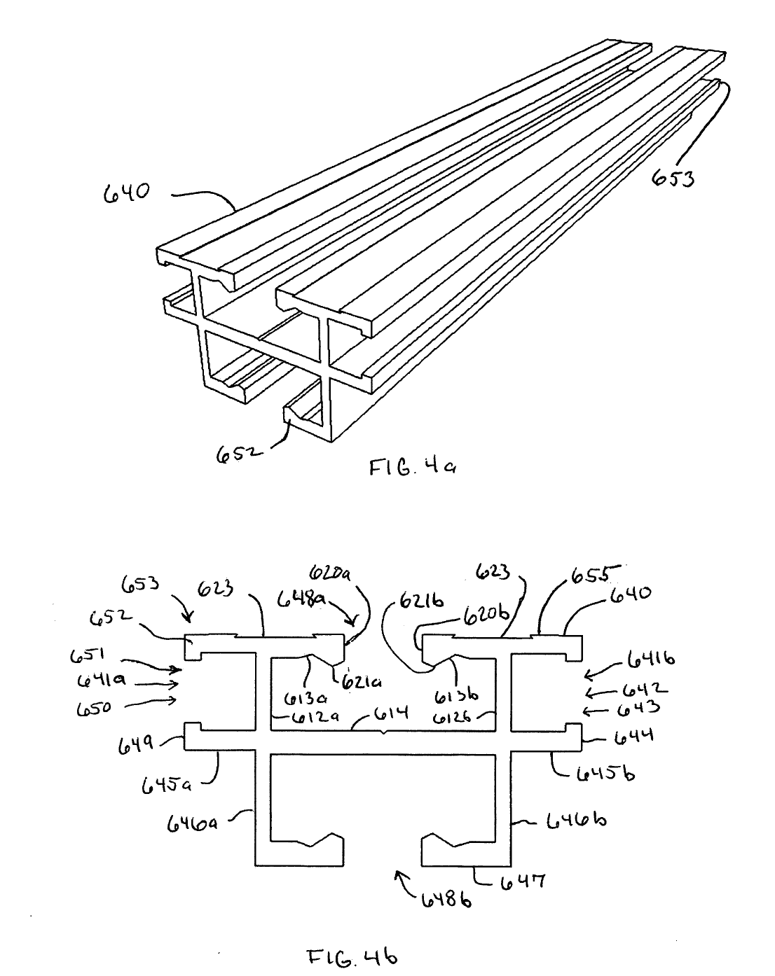

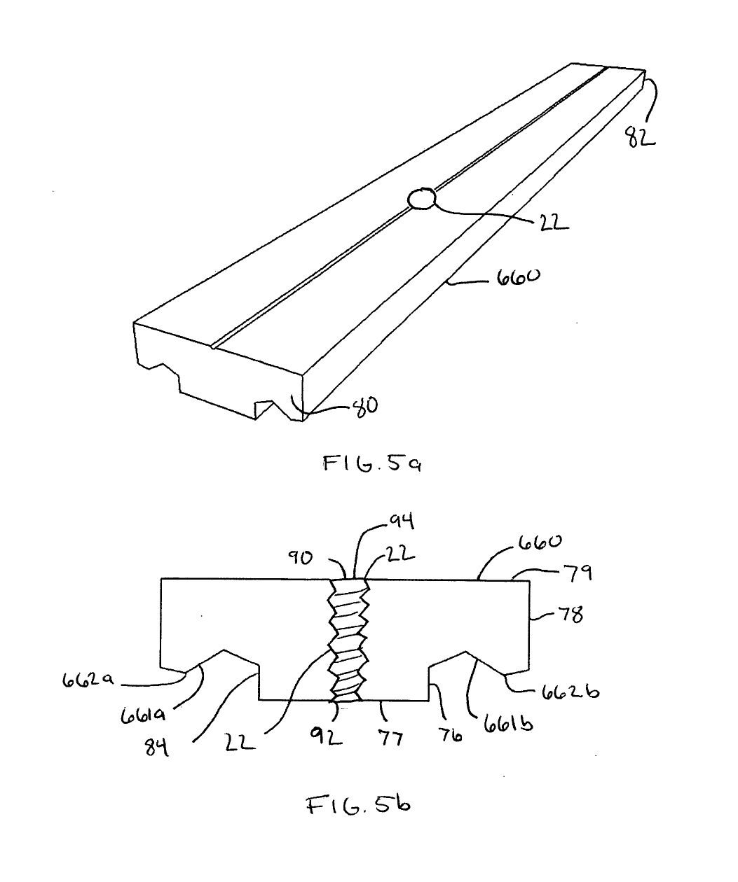

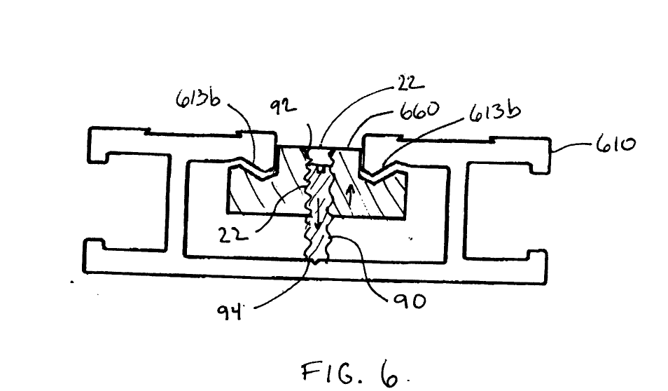

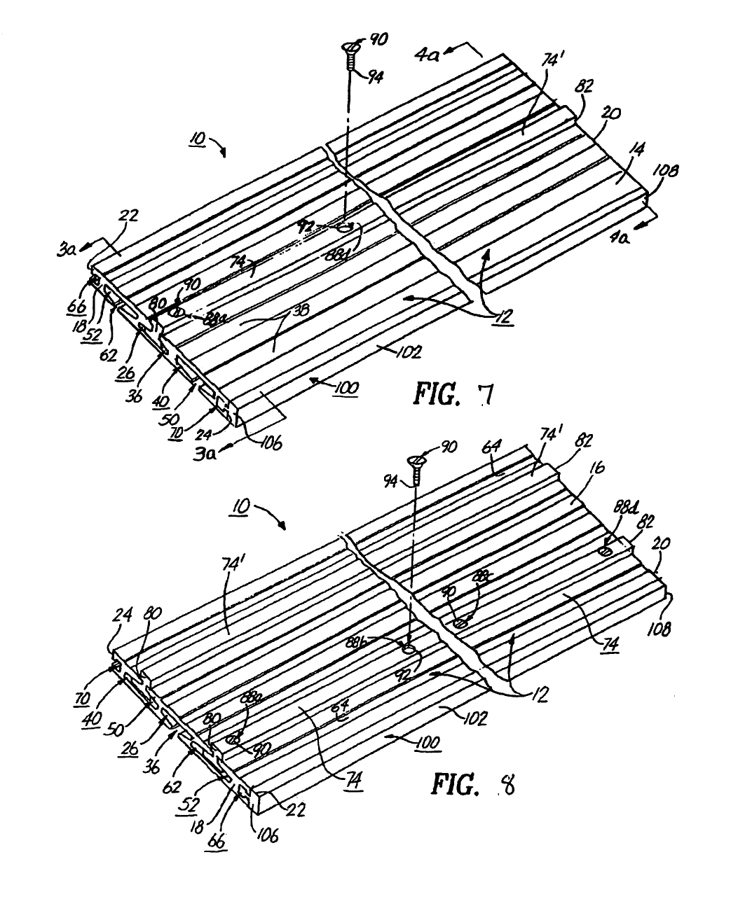

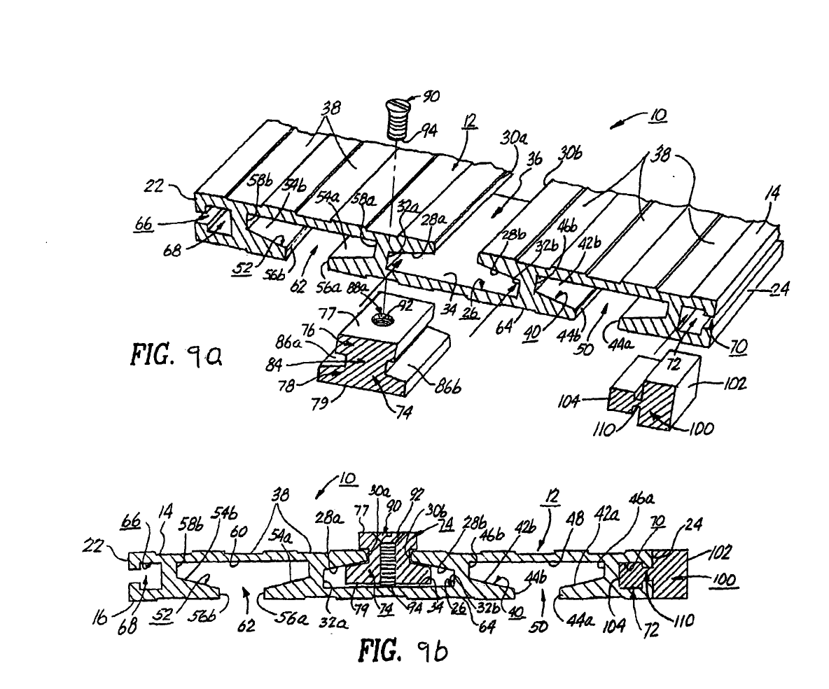

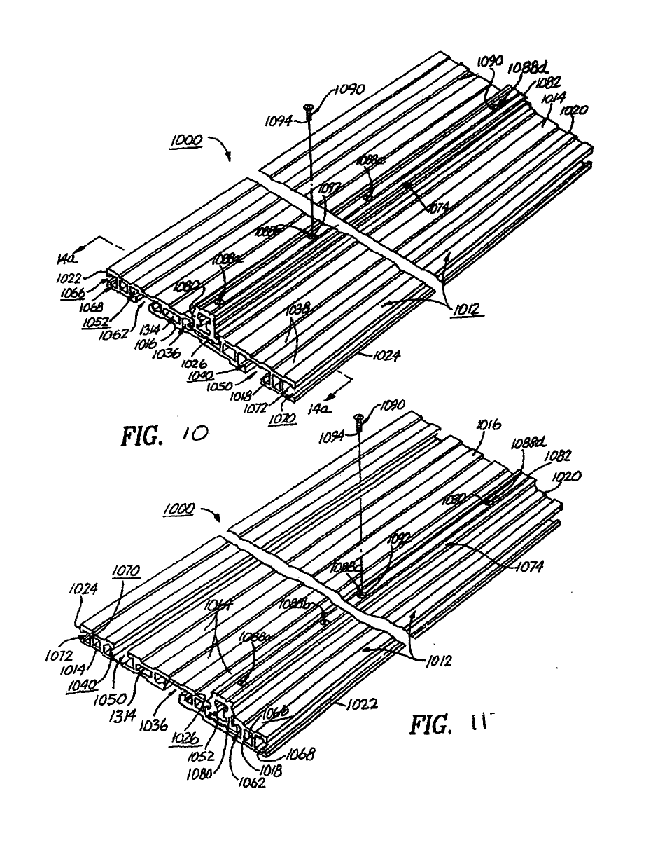

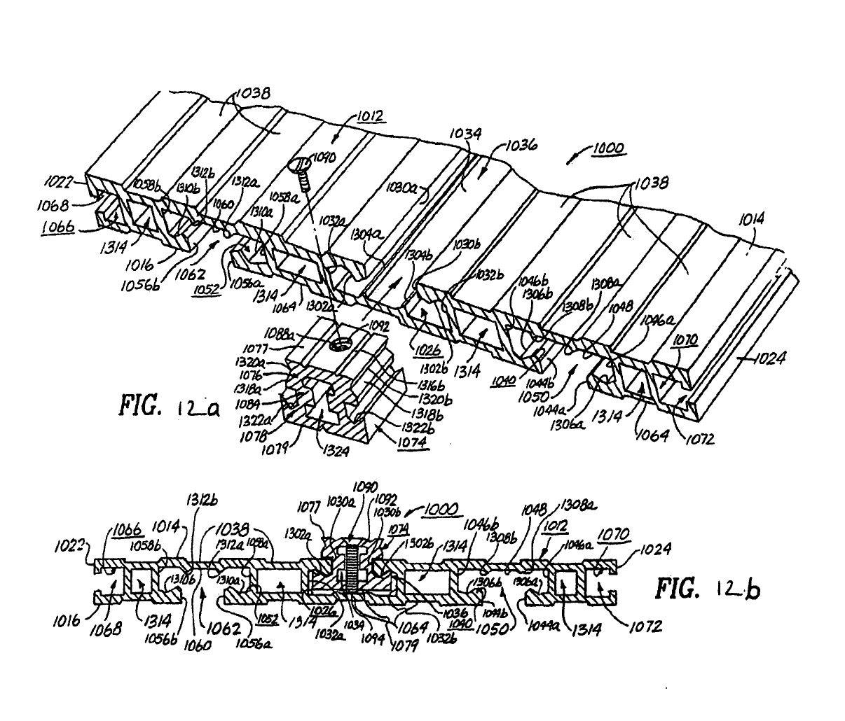

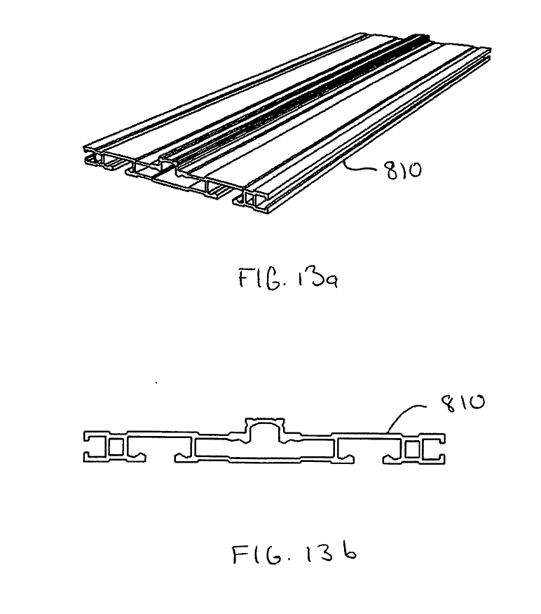

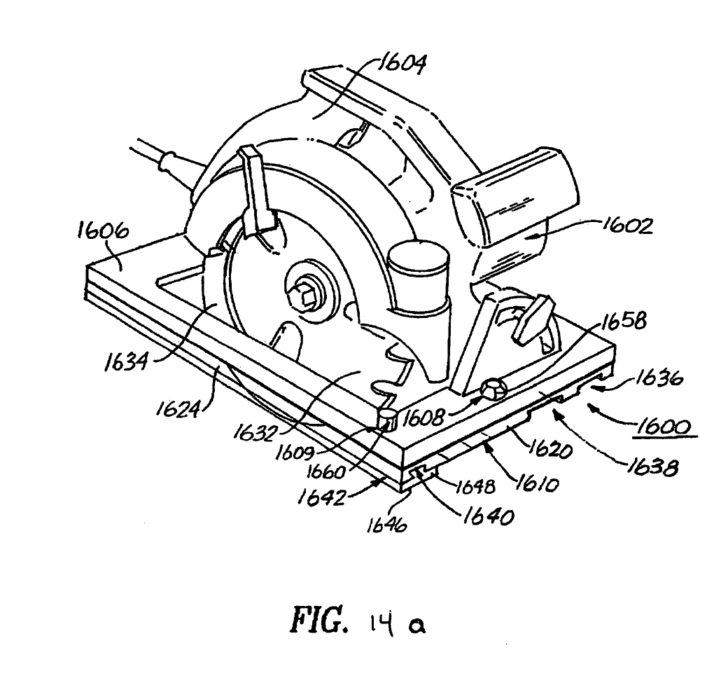

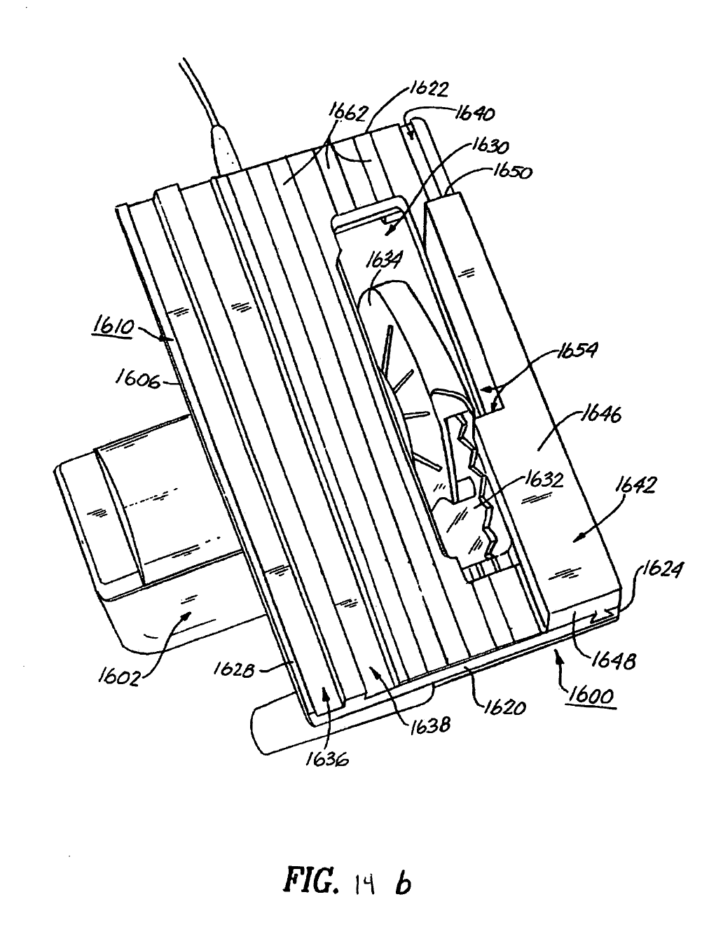

FIGS. 4a and 4b are perspective and end views, respectively, of a super sliding modular extrusion (SSME) 640 in accordance with an embodiment. The SSME 640 comprises an elongated member made from suitable materials, such as, but not limited to, aluminum, plastic, composite, metal and metal alloy.

The SSME 640 includes a first working surface 655, a second working surface 647, a front edge 652, a rear edge 653, a first perimeter side edge 649 and a second perimeter side edge 644. The first working surface 655 of SSME 640 includes an SME central channel 648a that is centrally (axially) positioned extending from the front edge 652 to the rear edge 653, along a longitudinal length of the SSME 640. The SSME central channel 648a includes a pair of V-notched grooves 613a, 613b, a plurality of vertically aligned, interior sidewall surfaces 620a, 620b, 612a and 612b and an interior base wall surface 614 defining a T-shape. The peak-shaped ribs 621a, 621b defining the V-notched grooves 613a, 613b are operable for cooperative engagement with elements of the connector 660 for self-centering of the connector 660 within the SSME central channel 648a (to be discussed hereinafter). The first working surface 655 of the SSME 640 optionally includes a plurality of relief elements 623 suitable for the deposit of, such as, but not limited to, sawdust, metal filings and the like, in order to not create a friction problem.

The second working surface 647 of the SSME 640 includes a SSME second central channel 648b that is centrally (axially) positioned extending from the front edge 652 to the rear edge 653, along a longitudinal length of the SSME 640 and adjacent to and symmetrical with the SSME first central channel 648a about axis Z. As with the SSME first central channel 648a, the SSME second central channel 633b includes a pair of V-notched grooves 613a, 613b, a plurality of vertically aligned, interior sidewall surfaces 620a, 620b, 612a and 612b and an interior base wall surface 614 defining a T-shape. The peak-shaped ribs 621a, 621b defining the V-notched grooves 613a, 613b are operable for cooperative engagement with elements of the connector 660 for self-centering of the connector 660 within the SSME second central channel 648b (to be discussed hereinafter).

The first perimeter side edge 649 includes a centrally positioned first sidetrack 650 extending from the front edge 652 to the rear edge 653, along the longitudinal length of SSME 640. The first sidetrack 650 includes a first tracking channel 651 that defines a square-shaped interior with an opening along the first perimeter side edge. The second perimeter edge side 644 includes a second sidetrack 642 extending from the front edge 652 to the rear edge 653, along the longitudinal length of guide plate SSME 640. The second sidetrack 642 also includes a tracking channel 643 that defines a square-shaped interior with an opening running the length of the second perimeter side edge.

The sidetrack 650, 642 are operable for receiving engagement elements as discussed hereinafter. The square-shaped interior is operable to slidingly receive a fastener, such as, but not limited to, a head of a bolt 6, therein which is captured by the lips 4, as shown in FIG. 2b.

The second working surface 647 of SSME 640 includes a SSME second central channel 648b that is centrally (axially) positioned extending from the front edge 652 to the rear edge 653, along a longitudinal length of the SSME 640 and adjacent to and symmetrical with the SSME first central channel 648a about axis Z. As with the SSME first central channel 648a, the SSME second central channel 648b includes a pair of V-notched grooves 613a, 613b, a plurality of vertically aligned, interior sidewall surfaces 620a, 620b, 612a and 612b and an interior base wall surface 11034 defining a T-shape. The peak-shaped ribs 621a, 621b defining the V-notched grooves 613a, 613b are operable for cooperative engagement with elements, such as, but not limited to, those on the connector 660 and the slide bar 1074 for self-centering of the slide bar 1074 and connector 660 (to be discussed hereinafter).

Connector

FIGS. 5a and 5b are perspective and end views, respectively, of a connector 660 comprising a substantially I-shaped elongated member in accordance with an embodiment. The connector 660 may be made from suitable materials, such as, but not limited to, aluminum, plastic, composite, metal and metal alloy. Each connector 660 is adapted to be slidingly received within the central channels 622, 633a,b, 648a,b of the SME 610, B2B 630, and SSME 640 respectively. The connector 660 includes an upper wall 76 having an upper surface 77, a lower base wall 78 having a lower surface 79, opposing end surfaces 80 and 82 and an integrally connected column 84 between the upper and lower walls 76 and 78.

FIG. 6 is a cross-sectional view of a SME 610 and a connector 660 in accordance with an embodiment. Referring to FIGS. 5a, 5b and 6, the connector 660 includes setscrew openings 22 for receiving a setscrew 90 in accordance with an embodiment. Each setscrew opening 22 may include a counter-sink groove 92. Each of the setscrew openings 22 extend from the upper surface 77 to the lower base surface 79. Each of the setscrews 90 are of sufficient length, such that each end tip 94 of the setscrew 90 urgingly engages the interior base wall surface 614. The connector 660 comprises v-shaped grooves 661a,b and ridges 662a,b. The connector 660 self-aligns within any one of the central channels, wherein the v-notched grooves 661a,b and peak-shaped ridges 662a,b of the connector 660 interact and cooperate with alignment elements such as the V-notched grooves 613a, 613b of the SME 610, as shown in FIG. 6.

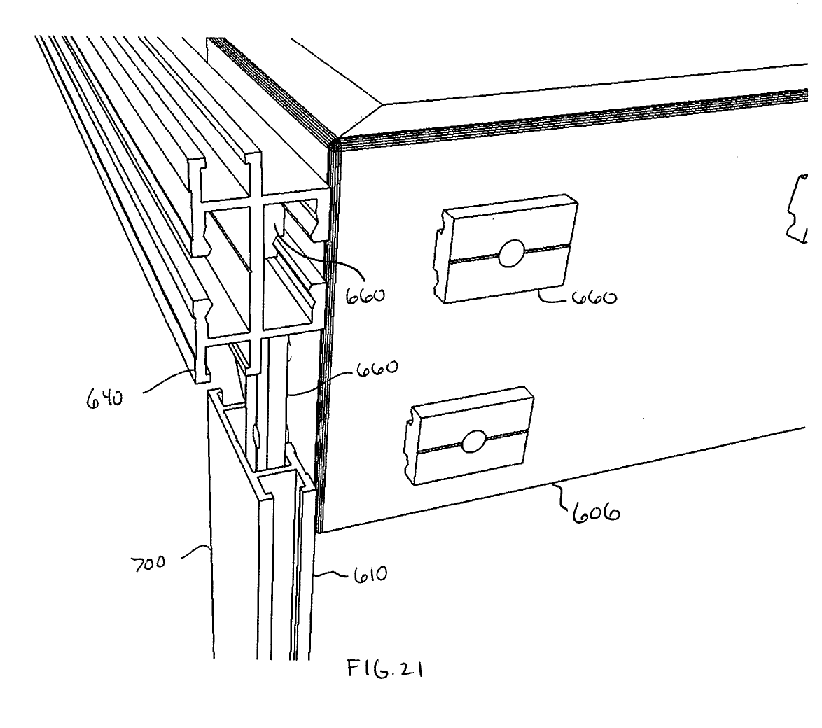

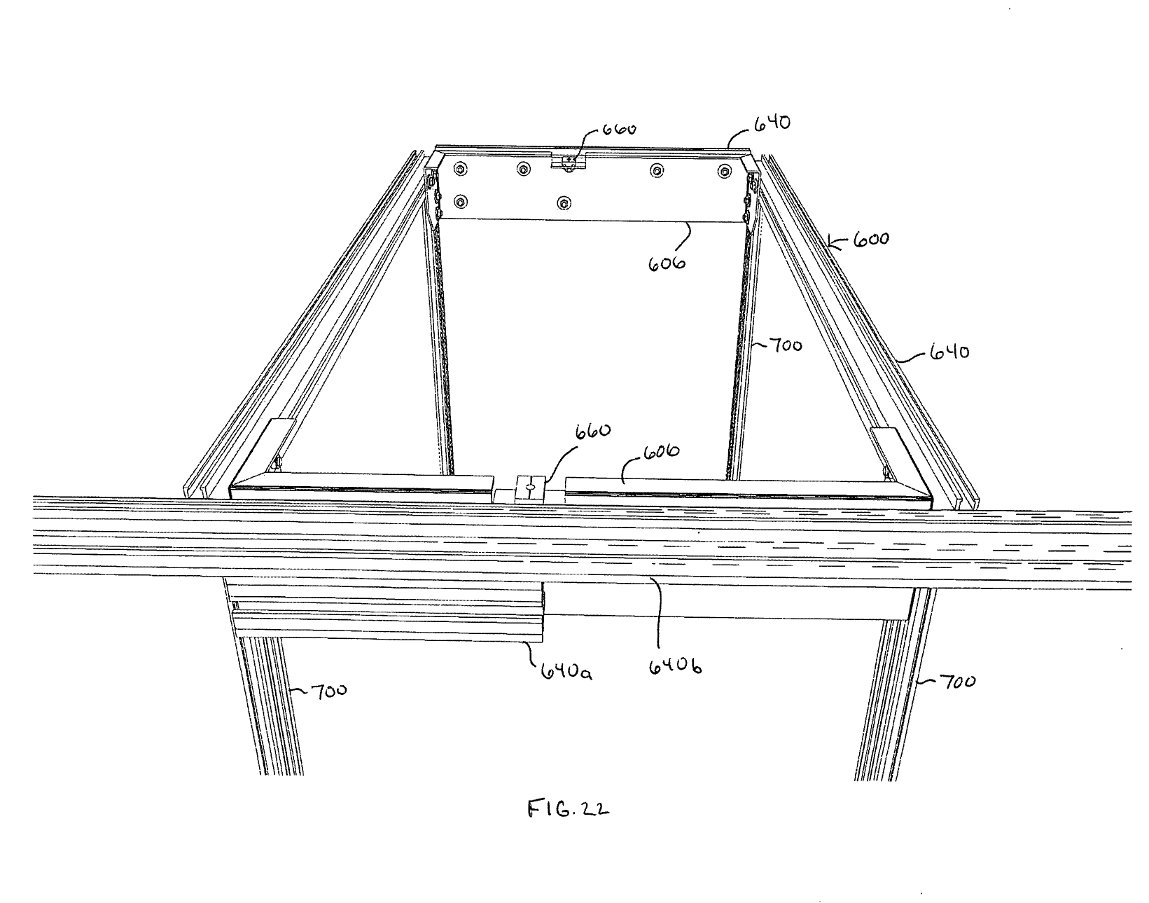

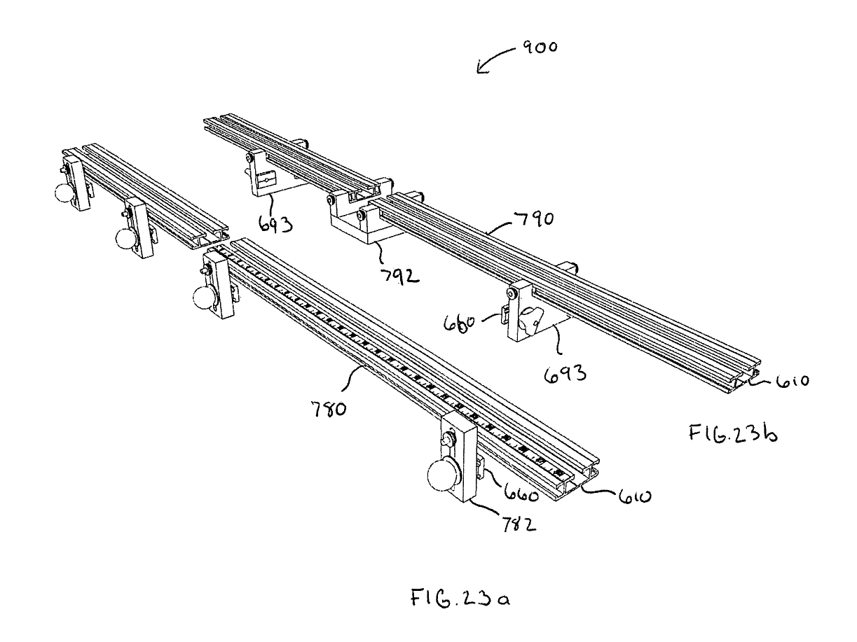

FIGS. 7 and 8 are perspective views, FIG. 9a is an exploded perspective view, and FIG. 9b is a cross-sectional view of an embodiment of a guide assembly 10. As shown in FIGS. 7 to 9b, the guide assembly 10 comprises a guide plate 12 made from a durable material, such as, but not limited to, aluminum, plastic, composite, metal and metal alloys. The guide plate 12 includes a first working surface area 14, a second working surface area 16, a front edge 18, a rear edge 20, a first perimeter side edge 22 and a second perimeter side edge 24. The first working surface area 14 of guide plate 12 includes a centrally positioned first T-shaped track 26 defining a T-shape extending from the front edge 18 to the rear edge 20 along the longitudinal length of guide plate 12. The T-shaped track 26 includes a pair of chamfered/beveled wall surfaces 28a, 28b, a plurality of vertically aligned interior sidewall surfaces 30a, 30b, 32a and 32b, and an interior base wall surface 34 that defines an interior T-shaped tracking channel 36. The first working surface area 14 of the guide plate 12 also includes relief elements 38 suitable to allow for the deposition of sawdust, metal filings and the like, in order to not create friction between the guide plate 12 and a sliding shoe, such as a sliding saw shoe 1610 shown in FIGS. 21a and 21b.

Referring again to FIGS. 7 to 9b, the second working surface area 16 includes a second T-shaped track 40 defining a T shape being positioned and adjacent to the first perimeter side edge 22 and extending from the front edge 18 to the rear edge 20 along the longitudinal length of guide plate 12. The second T-shaped track 40 includes a pair of chamfered/beveled wall surfaces 42a, 42b, a plurality of vertically aligned, interior sidewall surfaces 44a, 44b, 46a and 46b, and an interior base wall surface 48 that defines an interior T-shaped tracking channel 50. The second working surface area 16 also includes a third T-shaped track 52 defining a T shape being positioned and adjacent to the second perimeter side edge 24 and extending from the front edge 18 to the rear edge 20 along the longitudinal length of guide plate 12. The third T-shaped track 52 also includes a pair of chamfered/beveled wall surfaces 54a, 54b, vertically aligned interior sidewall surfaces 56a, 56b, 58a and 58b, and an interior base wall surface 60 defining an interior T-shaped tracking channel 62. The second working surface area 16 further includes relief elements 64 for the collection of sawdust, metal filings and the like as previously described.

With reference to FIGS. 7 to 9b, the first perimeter side edge 22 includes a centrally positioned first sidetrack 66 extending from the front edge 18 to the rear edge 20, along the longitudinal length of guide plate 12. The first sidetrack 66 includes an interior square-shaped tracking channel 68. The second perimeter edge side 24 also includes a centrally positioned second sidetrack 70 extending from the front edge 18 to the rear edge 20 along the longitudinal length of guide plate 12. The second sidetrack 70 also includes an interior square-shaped tracking channel 72.

Referring now to FIGS. 7, 8, 9a, 9b, the tracking channels 36, 50 and 62 for tracks 26, 40 and 52, respectively, are used for receiving one or more substantially I-shaped slide bars 74 therethrough. Slide bars 74 are made of extruded aluminum or other composite materials and, by way of example, but not limited thereto, may be provided in lengths of 24 inches and 48 inches. Each slide bar 74 includes an upper wall 76 having an upper surface 77, a lower base wall 78 having a lower surface 79, opposing end surfaces 80 and 82 and an integrally connected column 84 between the upper and lower walls 76 and 78. The column 84 includes opposing chamfered/beveled wall surfaces 86a, 86b integrally attached thereto. Each slide bar 74 includes one or more setscrew openings 88a, 88b, 88c or 88d (depending upon the length of slide bar 74 with more setscrew openings for longer lengths) for receiving a setscrew 90. Each setscrew opening 88a, 88b, 88c and 88d includes a counter-sink groove 92. Each of the setscrew openings 88a-d extend from the upper surface 77 to the lower base surface 79. Each of the setscrews 90 are of sufficient length, such that each end tip 94 of the setscrew 90 urgingly engages the interior base wall surfaces 34, 48 or 60 of tracking channels 36, 50 or 62, respectively, as depicted in FIG. 3b. The slide bar(s) 74 self-aligned within any one of the tracking channels 36, 50 or 62, wherein the slide bar(s) 74 interact with the handheld tools.

Referring to FIGS. 7 to 9b once again, the square-shaped tracking channels 68 and 72 for tracks 66 and 70, respectively, are used for receiving one or more substantially I-shaped positioning edge bar(s) 100 therethrough. The positioning edge bars 100 are made of wood, plastic or other suitable materials and have lengths of 24 inches or 48 inches. Each edge bar 100 includes an outer wall 102, an inner wall 104, opposing end wall surfaces 106, 108, and an integrally connected column 110 between the outer and inner walls 102 and 104. The edge bar 100 is used for the positioning extension and protection of the guide plate 12. By using the edge bar 100, the positioning line and cutting line are the same, thus eliminating the offset measurements. Another use for tracking channels 68, 72 is to receive an optional side clamp assembly.

FIGS. 10 and 11 are perspective views, FIG. 12a is an exploded perspective view, and FIG. 12b is a cross-sectional view of another embodiment of a guide assembly 1000. Elements illustrated in FIGS. 10 to 12b which correspond to the elements described above with reference to FIGS. 7 to 9b have been designated by corresponding reference numbers increased by one thousand. This embodiment is constructed and operates in the same manner as the previous embodiment of the guide assembly 10, unless it is otherwise stated.

The guide assembly 1000 includes a guide plate 1012 that made me made from, such as but not limited to, aluminum, plastic, composite, metal and metal alloys. The guide plate 1012 includes a first working surface area 1014, a second working surface area 1016, a front edge 1018, a rear edge 1020, a first perimeter side edge 1022 and a second perimeter side edge 1024. The first working surface area 1014 of guide plate 1012 includes a centrally positioned first T-shaped track 1026 extending from the front edge 1018 to the rear edge 1020, along the longitudinal length of guide plate 1012. The first T-shaped track 1026 includes a pair of V-notched grooves 1302a, 1302b, a plurality of vertically aligned, interior sidewall surfaces 1030a, 1030b, 1032a and 1032b and an interior base wall surface 1034 having a pair of centrally positioned peak-shaped ribs 1304a, 1304b thereon for forming an interior T-shaped tracking channel 1036. The peak-shaped ribs 1304a, 1304b are used for strengthening and self-centering of the slide bar 1074 (to be discussed hereinafter). The first working surface area 1014 of guide plate 1012 also includes a plurality of relief elements 1038 for the deposit of sawdust, metal filings and the like, in order to not create a friction problem when the guide plate 1012 is in operation.

Referring again to FIGS. 10 to 12b, the second working surface area 1016 includes a second T-shaped track 1040 being positioned and adjacent to the first perimeter side edge 1022 and is extending from the front edge 1018 to the rear edge 1020, along the longitudinal length of guide plate 1012. The second T-shaped track 1040 includes a pair of V-notched grooves 1306a, 1306b, vertically aligned, interior sidewall surfaces 1044a, 1044b, 1046a and 1046b, and an interior base wall surface 1048 having a pair of centrally positioned peak-shaped ribs 1308a, 1308b thereon for forming an interior T-shaped tracking channel 1050. The second working surface area 1016 also includes a third T-shaped track 1052 being positioned and adjacent to the second perimeter side edge 1024 and is extending from the front edge 1018 to the rear edge 1020, along the longitudinal length of guide plate 1012. The third T-shaped track 1052 includes a pair of V-notched grooves 1310a, 1310b, a vertically aligned, interior sidewall surfaces 1056a, 1056b, 1058a and 1058b, and an interior base wall surface 1060 having a pair of centrally positioned peak-shaped ribs 1312a, 1312b thereon for forming an interior T-shaped tracking channel 1062. The second working surface area 1016 further includes a plurality of relief elements 1065 for the collection of sawdust, metal filings and the like.

The guide plate 12 further includes rectangular-shaped weight relief channels 1314. The weight relief channels 1314 extend from the front edge 1018 to the rear edge 1020, along the longitudinal length of guide plate 1012. The weight relief channels 1314 of guide plate 1012 provide for a reduction in total weight, as compared to the total weight of guide plate 12 of the first embodiment.

Referring now to FIGS. 10, 11, 12a and 12b, the tracking channels 1036, 1050 and 1062 for tracking 1026, 1040 and 1052, respectively, are used for receiving one or more substantially I-shaped slide bars 1074 therethrough. Slide bars 1074 are made of extruded aluminum, plastic or other composite materials and have lengths of 24 inches or 48 inches. Each slide bar 1074 includes an upper wall 1076 having an upper surface 1077 with a pair of spaced-apart notched grooves 1316a, 1316b thereon and having upper sidewall surfaces 1318a, 1318b each with a notched groove 1320a, 1320b thereon, a lower base wall 1078 having a lower surface 1079, opposing end surfaces 1080, 1082 and an integrally connected column 1084 between the upper and lower walls 1076 and 1078. The lower base wall 1078 includes opposing notched ribs 1322a, 1322b being integrally attached thereto. Each slide bar 1074 includes two or more setscrew openings 1088a, 1088b, 1088c or 1088d (depending upon the length of slide bar 1074) for receiving a setscrew 1090 therein. Each setscrew opening 1088a, 1088b, 1088c and 1088d includes a counter-sink groove 1092 therein. Each of the setscrew openings 1088a to 1088d extend from the upper surface 1077 to the lower base surface 1079. Each of the setscrews 1090 are of sufficient length, such that each end tip 1094 of the setscrew 1090 urgingly engages the interior base wall surfaces 1034, 1048 or 1060 of tracking channels 1036, 1050 or 1062, respectively, as depicted in FIG. 6. The slide bar(s) 1074 become self-aligned within any one of the tracking channels 1036, 1050 or 1062, wherein the slide bar(s) 1074 will interact with the handheld tools.

Additionally, the slide bar 1074 includes an I-shaped weight relief channel 1324. The I-shaped weight relief channel extends from the front opposing end surface 1080 to the rear opposing end surface 1082, along the longitudinal length of slide bar 1074 as shown in FIG. 6. The notched grooves 1316a, 1316b, 1320a, 1320b on the upper wall 1076 of slide bar 1074 will interfit with various tool attachment assemblies.

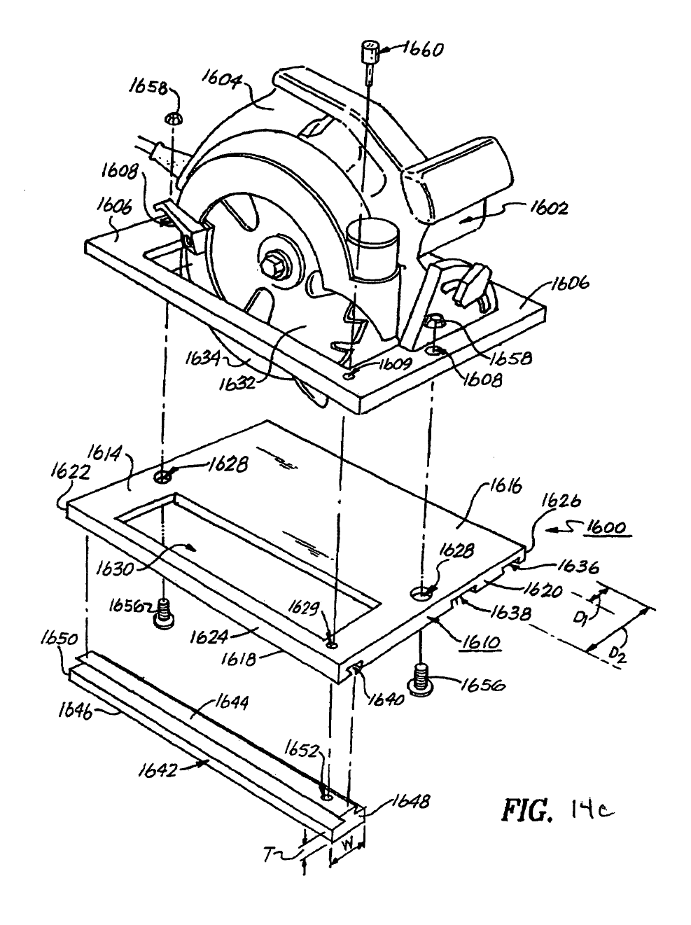

It is appreciated that the guide assembly 10, 1000 having the profile of the guide plate 1012 and the slide bar 1074 may be manufactured as a single piece of material. FIGS. 13a and 13b are perspective and end views, respectively, of a unitary guide assembly referred herein as a guide track 810. Guide track 810 comprises substantially the same elements and substantially the same function as the guide assembly 10, 1000.

The guide assembly 10, 1000, and guide track 810 are used with various handheld tools each having an attachment assembly used in conjunction with the universal guide assembly 10 or 1000. Each attachment assembly for a given tool is unique in its structure and operation, such as provided in U.S. Pat. No. 7,621,206 reference to which is directed, and incorporated herein by reference.

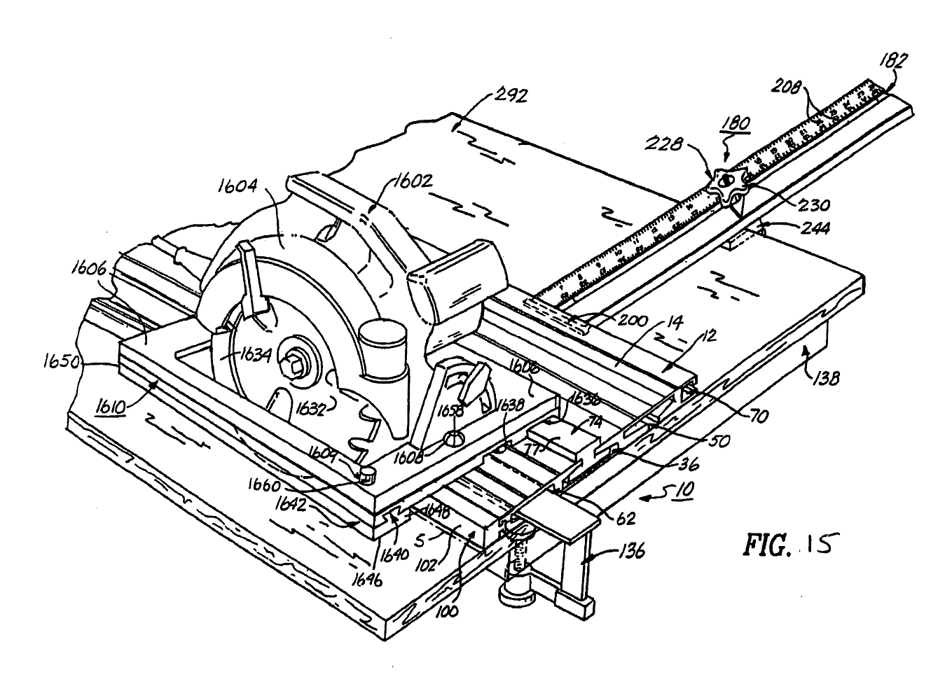

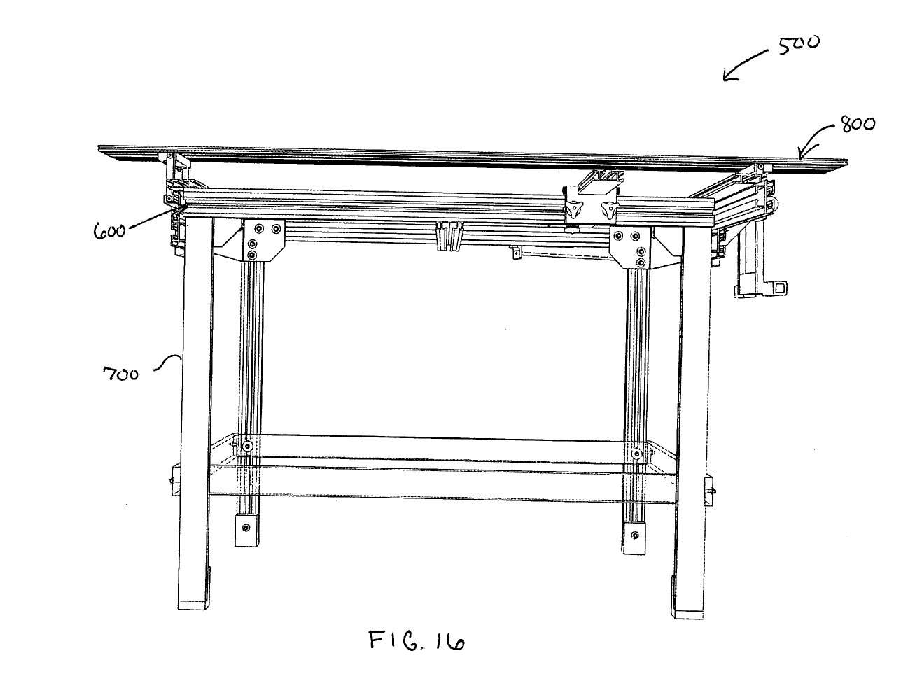

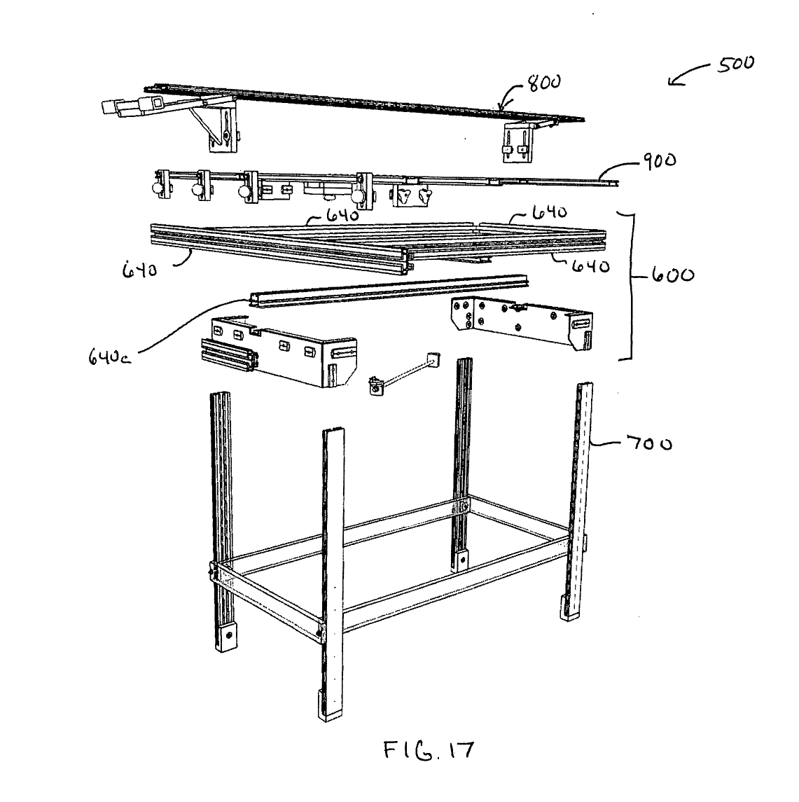

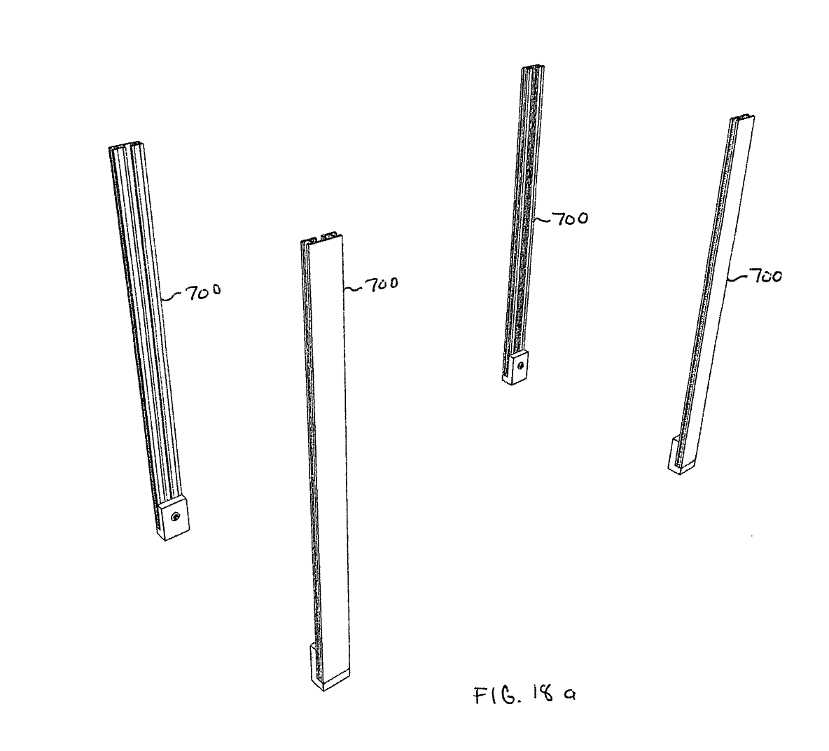

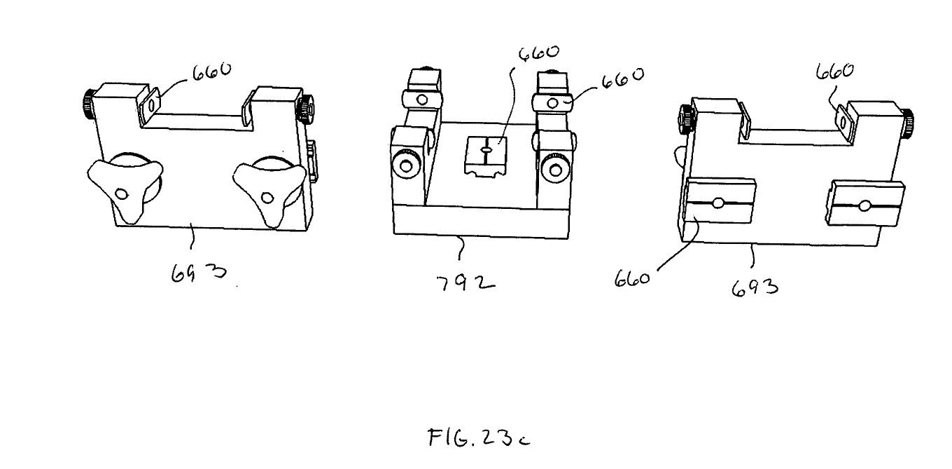

FIGS. 14a, 14b, and 14c are top, bottom, and exploded perspective views, respectfully, of a circular saw attachment assembly 1600 for use with a conventional portable, handheld circular saw 1602, by way of example. The circular saw 1602 includes a housing 1604 having a base plate 1606. The base plate 1606 includes a pair of threaded mounting openings 1608 and a retainer pin opening 1609 therethrough. The saw attachment assembly 1600 includes a sliding saw shoe 1610 having a proximal end 1612 and a distal end 1614. The sliding saw shoe 1610 also includes a top wall surface 1616, a bottom wall surface 1618, a front-end wall 1620, a rear end wall 1622 and sidewalls 1624, 1626. The sliding saw shoe 1610 further includes a pair of mounting openings 1628 and a retainer pin opening 1629 and a rectangular opening 1630 for receiving of a circular saw blade 1632 and a blade guard 1634 therethrough as shown in FIGS. 14a, 14b of the circular saw 1602. The bottom wall surface 1618 includes a 45° cut tracking channel 1636, a 90° cut tracking channel 1638 and a dove-tailed receiving channel 1640 for receiving of an anti-split sliding bar 1642 therein. The anti-split sliding bar 1642 includes a top wall surface 1644, a bottom wall surface 1646, a front-end wall 1648 and a rear end wall 1650. The top wall surface 1644 includes a retainer pin opening 1652 being adjacent to the front-end wall 1648. The bottom wall surface 1646 includes an L-shaped notched section 1654 for receiving a portion of the saw blade 1632 thereto as shown in FIG. 14a. The optional anti-split sliding bar 1642 prevents the cut workpiece 292 from splitting or splintering while being cut. The anti-split sliding bar 1642 has a thickness T which is also the same thickness of guide plate 12, allowing the saw sliding shoe 1610 to be level relative to the surface of the workpiece 292. Also, the anti-split sliding bar 1642 has a width W, in which width W represents a particular saw blade thickness. The anti-split sliding bar 1642 can be sized for any saw blade thickness, as different widths W represent different saw blade thicknesses as shown in FIG. 22. The 45 degrees cut tracking channel 1636 is used when a 45° beveled side edge is desired on the working piece 292, and the 90° cut tracking channel 1638 is used when a 90° straight edge is desired on the working piece 292. The tracking and receiving channels 1636, 1638 and 1640, respectively, extend along a longitudinal axis from the front-end wall 1620 to the rear end wall 1622. The saw sliding shoe 1610 is mounted to the base plate 1606 of circular saw 1602 by alignment of mounting openings 1628, 1608, of sliding shoe 1610 and base plate 1606, respectively, for receiving of a mounting bolt and nut 1656 and 1658 therethrough as shown in FIGS. 14a and 14b. The anti-split sliding bar 1642 is kept in place and from moving within the receiving channel 1640 by the alignment of the retainer pin openings 1609, 1629, 1652 of base plate 1606, of sliding shoe 1610 and of sliding bar 1642, respectively, for receiving a retainer pin 1660 therethrough. The bottom wall surface 1618 also includes a plurality of relief elements 1662 thereon for the collection of sawdust, metal filings and the like. The dust relief elements 1662 of sliding shoe 1610 are provided such that the user does not have to push the sawdust under the guide plate 12 but instead the sawdust is between the relief elements 1662 on the sliding shoe 1610 and the relief elements 64 on the guide plate 12 without compromising the sliding of the sliding shoe 1610 relative to the clamped guide plate 12 when using the circular saw 1602 in cutting the workpiece 292 as shown in FIG. 15. The sliding shoe 1610 and guide plate 12 when attached with each other, only allows an opening that is as wide as the saw blade 1632, and very little sawdust escapes. The space between the bottom wall surface 1618 of sliding shoe 1610 and the working surface 16 of guide plate 12 is able to retain approximately 90 to 95% of the sawdust generated by circular saw 1602 when cutting a piece of plywood. Also, the unused tracking channel 1636 or 1638 becomes a sawdust relief channel for retaining the sawdust generated by circular saw 1602. This sawdust retention by sliding shoe 1610 and guide plate 12 provides a healthier and safer environment for the operator.

The circular saw sliding shoe 1610 can be designed as an original part of the circular saw 1602 or the saw sliding shoe 1610 can be provided as an add-on accessory. The circular saw attachment assembly 1600 with the guide plates 12 and 12′ of the universal guide assembly 10 provides for full access to any surface area within a particular workpiece 292, such as, but not limited to a 4 foot by 8 foot sheet of plywood, in order to cut anywhere on that surface or workpiece 292 by circular saw 1602. There are no blind spots on the surface of the workpiece 292 when using attachment assembly 1600 and the guide plate(s) 12, 12′ together as shown in FIG. 15. In operation, as shown in FIG. 15, the user clamps the universal guide assembly 10 to the workpiece 292 by slide under clamps 136 in order to hold in position one or more guide plates 12, 12′ to the workpiece 292, as well as a side extension clamping assembly 180. Slide bar 74 and edge bar 100 are appropriately positioned within tracking channels 50 and 72, respectively, of guide plate 12. The operator then positions either the 45° cut tracking channel 1636 or the 90° cut tracking channel 1638 of the circular saw attachment assembly 1600 on the upper surface 77 of slide bar 74 (depending upon the type of edge, 45° or 90°, the user desires on workpiece 292). By positioning the tracking channels 1636 and 1638 at precise distances D₁ and D₂ relative to the outer side 1626 of sliding shoe 1610, both of the tracking channels 1638 and 1638 can use the same slide bar 74, thus when making either a 45° or 90° cut, both are done at the same cutting line S. Further, by placing either one of the tracking channels 1636 or 1638 on the slide bar 74 of guide plate 12 at the predetermined cutting line S, the operator eliminates the need to offset the guide plate 12 on the surface of the workpiece 292 which always avoids the inaccurate placement of the guide plate 12 relative to the cutting line S. Also, minimal trimming is easily achieved by placing the outer wall 102 of edge bar 100 (guide plate 12) on the desired position (cut line S) of the workpiece 292 while being cut by saw blade 1632. The operator then slides the anti-split sliding bar 1642 into the dove-tailed receiving channel 1640, where then the sliding bar 1642 is retained via the retainer pin 1660 being received through retainer openings 1609, 1629, 1652 accordingly. Typically, when cutting a piece of plywood 292 with a circular saw 1602, the saw blade 1632 rotates in a counter-clockwise movement such that the underside of plywood is cut clearly and the top side of the plywood tends to be jagged and/or splintered. This problem is eliminated with the use of the anti-split sliding bar 1642 within the receiving channel 1640 of sliding shoe 1610. None of the prior art circular saw guide devices offer this type of protection to the workpiece 292 for preventing splintering of the workpiece 292. The guide plate 12 also offer the benefits of an anti-split device because the cutting line is always at the outer wall 102 of edge bar 100 in which to hold down the guide plate 12 to the workpiece 292 as shown in FIG. 15. When in operational use, the saw blade 1632 is between the anti-split sliding bar 1642 and the outer wall 102 of edge bar 100 which allows a clean saw cut through workpiece 292 without splintering or damage to the saw blade 1632. The disengage the circular saw 1602 from the slide bar 74 on guide plate 12, the user simply lifts the circular saw 1602 and the attached saw attachment assembly 1600 vertically from the workpiece 292.

Guide Table

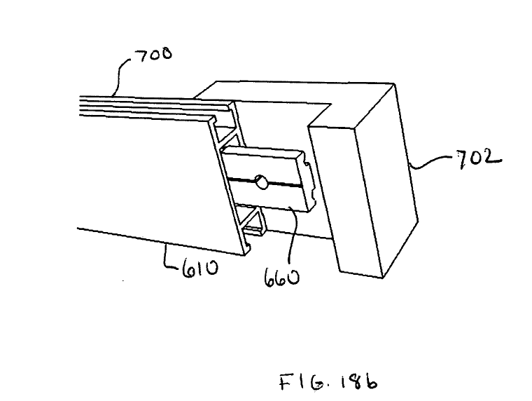

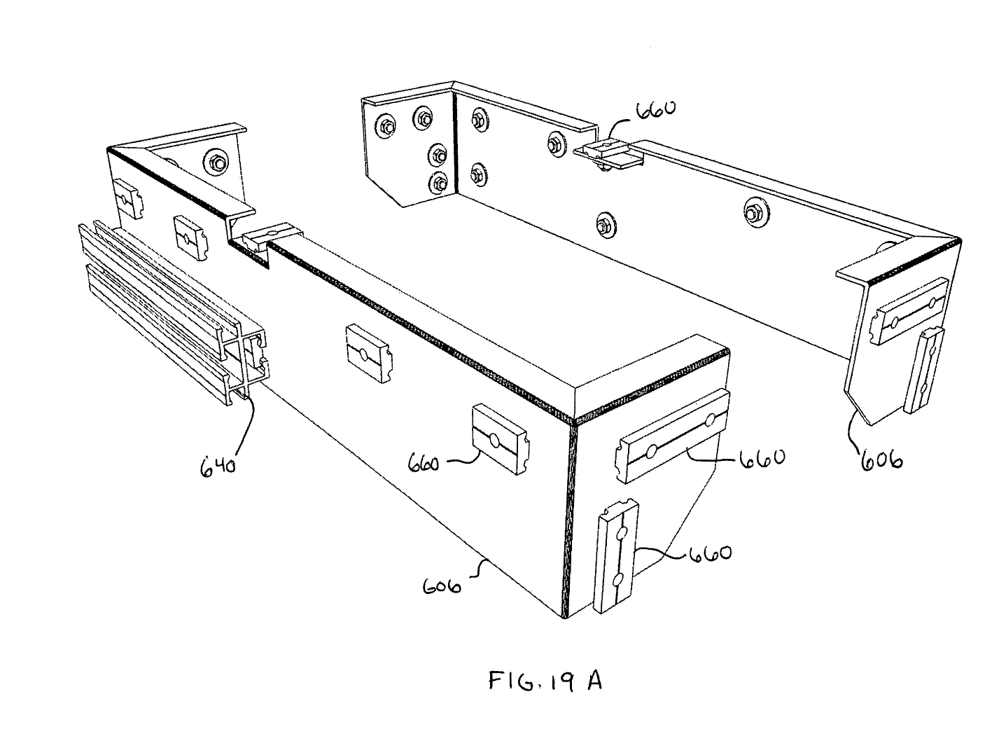

FIGS. 16 and 17 are side and exploded views, respectively, of the guide table 500 of the embodiment of FIG. 1. The guide table 500 comprises a top frame 600, a plurality of legs 700, a bridge assembly 800, and a plurality of sliding fences 900. The top frame 600 comprises four SSMEs 640 defining a substantially rectangular perimeter of the frame 600 as will be discussed hereinafter.

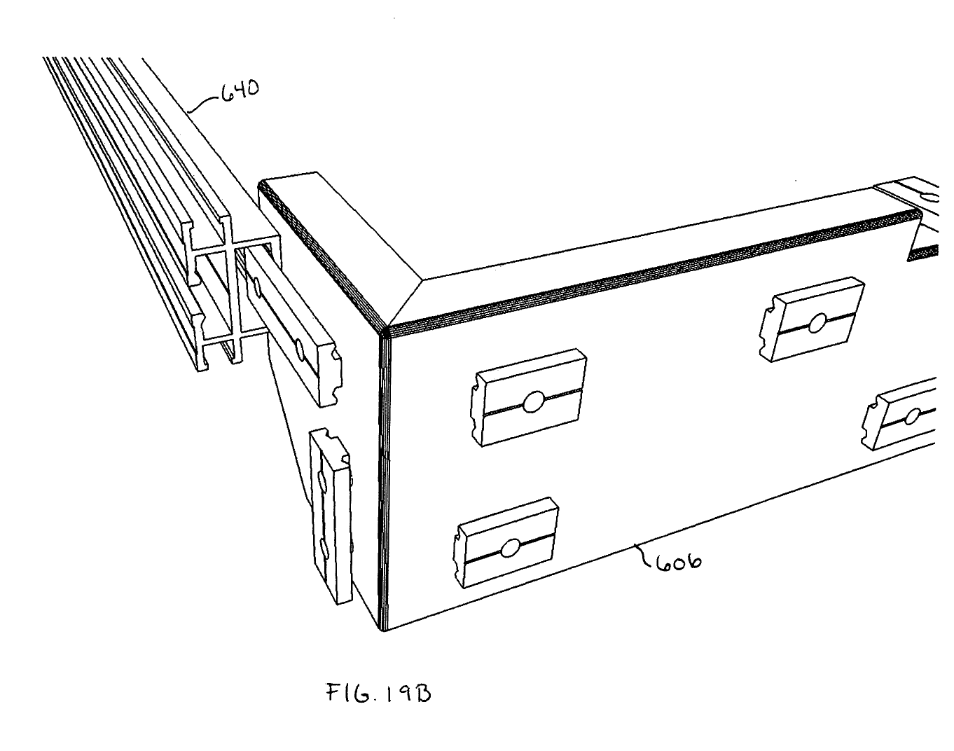

FIG. 18a is a perspective view of the four legs 700, in accordance with an embodiment. FIG. 18b is a perspective partially disassembled view of the leg 700 including an SME 610, connector 660, and a foot 702. The foot 702 is an L-shaped element wherein a connector 660 is coupled to an inside surface such that it the connector 660 may be received within the central channel 648b of the SME 610.

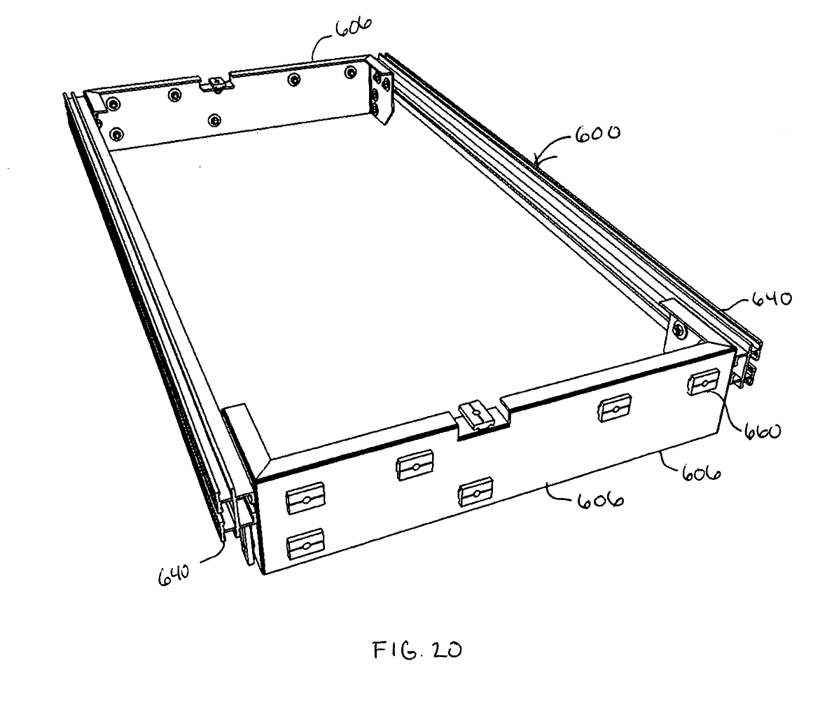

FIG. 19a is a perspective view of two frame end connectors 606, in accordance with an embodiment. Each frame end connector 606 is generally U-shaped and defines the rectangular shape of the ends of the frame 600, as shown in FIG. 20. A plurality of connectors 660 are coupled to the frame end connectors 606, the function of which are shown hereinafter, such as, but not limited to coupling any of the SME 610, B2B 630, and SSME 640 to the frame end connector 606.

FIG. 19 is a perspective view of an SSME 610 being received over a connector 660 that is coupled to one of the two frame end connectors 606, in accordance with an embodiment.

FIG. 20 is a perspective view of two frame end connectors 606 coupled together with two SSME 640 forming the frame 600, in accordance with an embodiment.

FIG. 21 is a partial perspective view of an assembly wherein the leg 700 comprises an SME 610 being received onto a connector 660 that is coupled to the frame end connector 606, in accordance with an embodiment.

FIG. 22 is a perspective view of the frame 600 of FIG. 20 coupled to four SMEs 610 forming the legs 700, and having received two SSMEs 640 on connectors 660 on the frame end connectors 606, in accordance with an embodiment. A first SSME 640a is provided as a coupling structure for the bridge 800. A second SSME 640b is provided as a workpiece support.

Referring again to FIG. 17, the guide table 500 comprises a central SSME 640a extending from the front of the frame 600 to the back of the frame 600 coupled to the top of the frame 600. The central SSME 640a, used in cooperation with the bridge assembly 800, provides a central channel that may receive a blade of a circular saw, for example. The guide table 500 further comprises a plurality of perpendicular SMEs that slide with respect to the central SSME which will be discussed hereinafter.

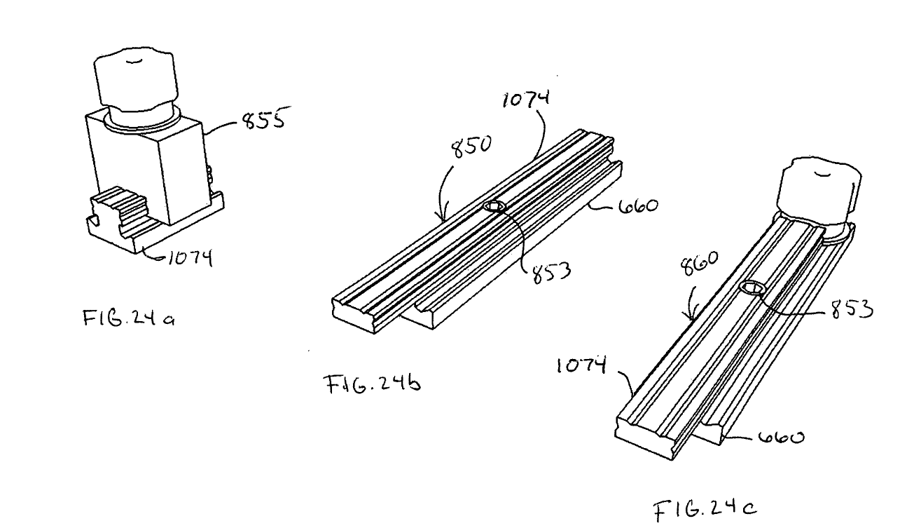

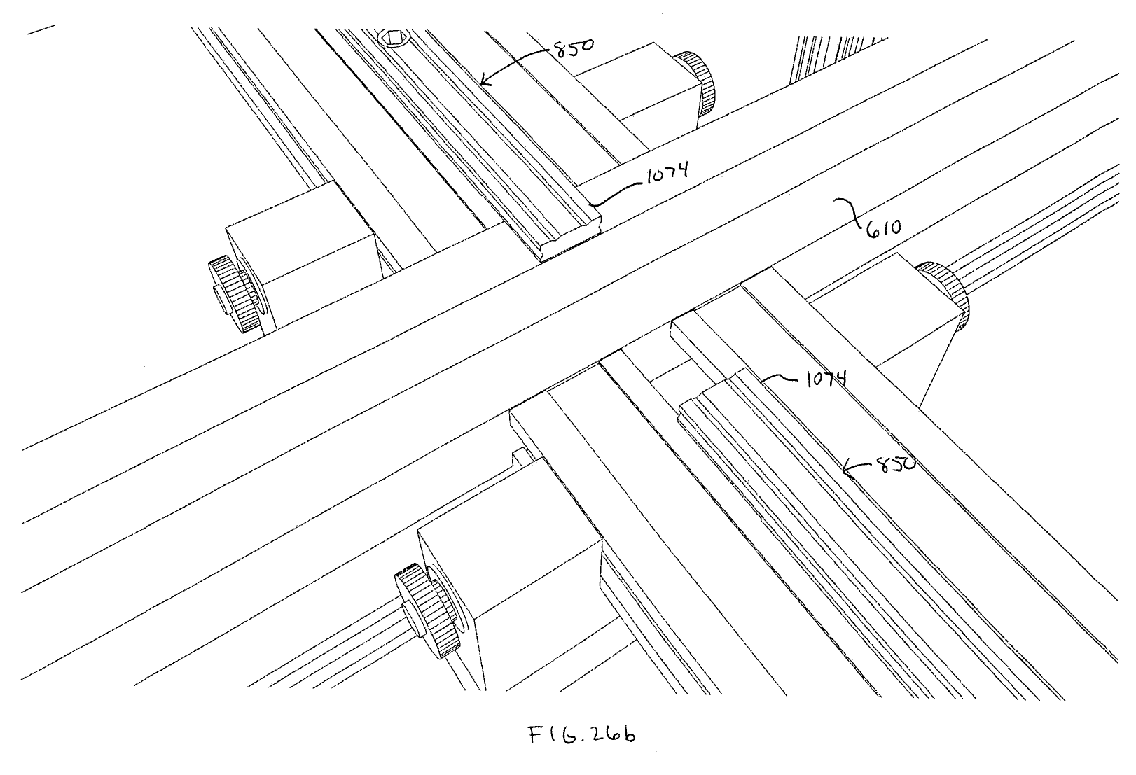

FIG. 23a is a fence 780 that comprises one or more sliding squaring stops 782 that couple to the SME 610 with connector 660, in accordance with an embodiment. The sliding squaring stop 782 extends above the SME 610 so at to support a workpiece there-against. The sliding squaring stop 855 couples to the frame SSME 640 by engagement of a connector 660 in the central channel of the frame SSME 640 and by a fastener within the peripheral edge of the top SME 610, in accordance with an embodiment. The sliding squaring stop 782 may slide within the respective channels by loosening the knobs 783. The sliding squaring stop 782 provides support for a workpiece to engage against. In the embodiment of FIG. 25, top SMEs 610 are coupled to the frame SSMEs 640 to form a modified frame 600 to support additional components within the central channels of the top SMEs 610, as will be shown hereinafter.

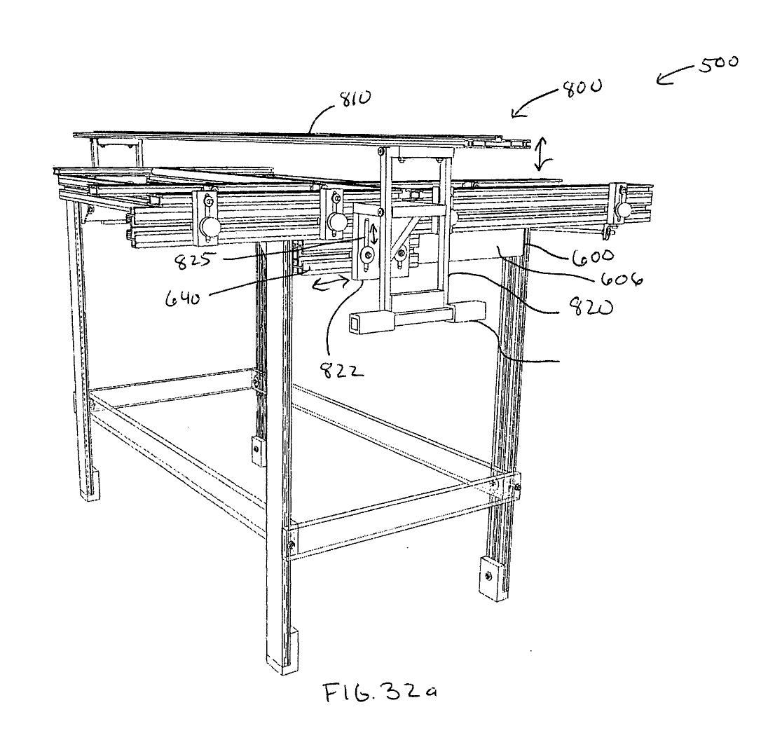

FIG. 23b is a sliding support 790 that comprises one or more sliding brackets 693, 792 that may couple to the SME 610 with connector 660, in accordance with an embodiment. The sliding brackets 693, 792 are operable to advance along a SME 610 to provide a support that may be repositioned at any location along the SME 610, as shown in FIG. 31.

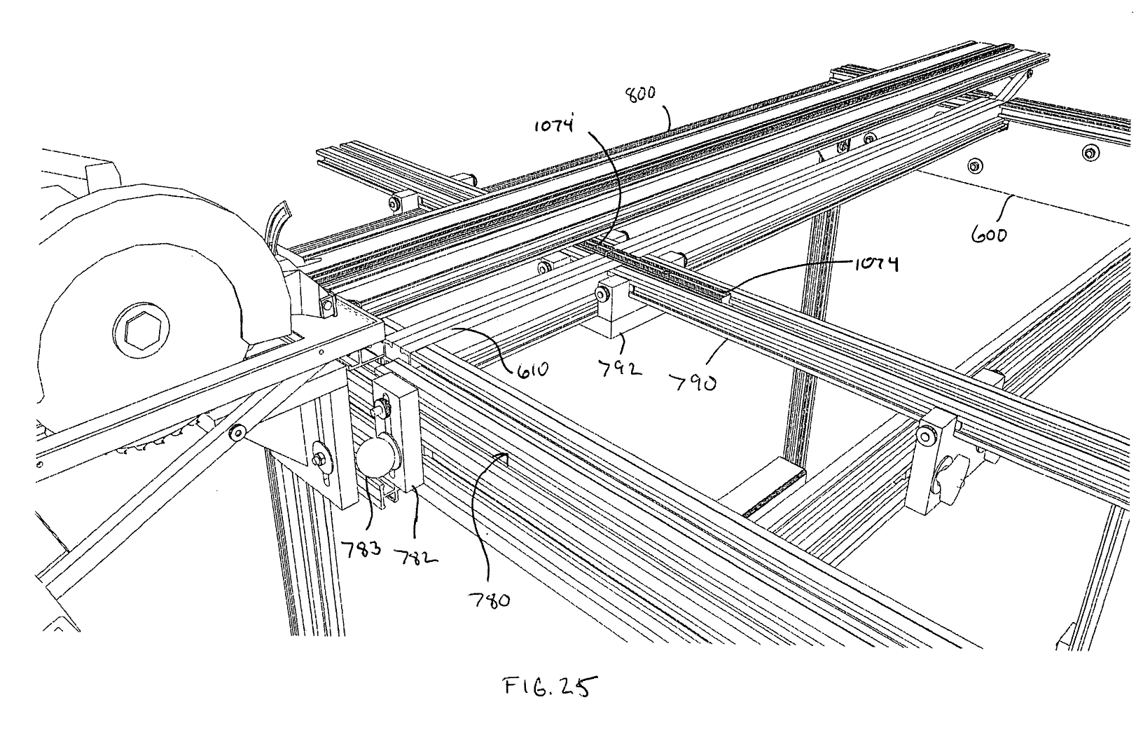

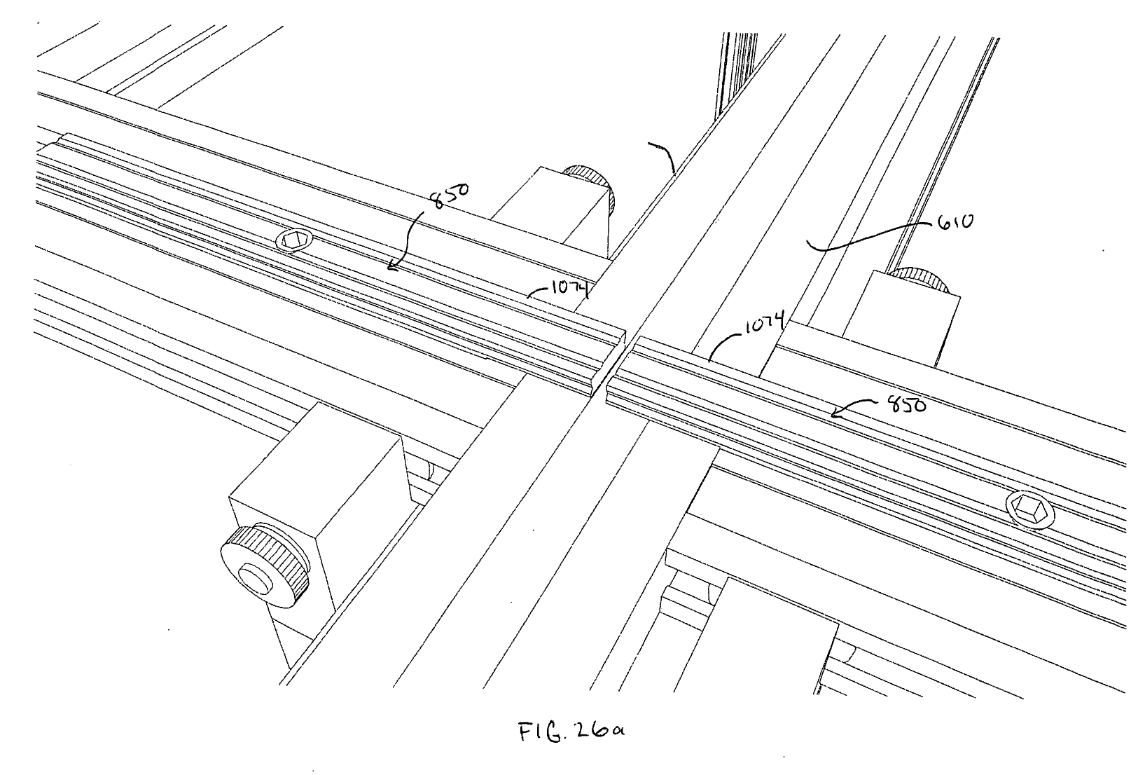

FIG. 24a is a perspective view of a slide bar stop 855 that may couple to the slide bar 1074 of a guide track 810. The slide bar stop 855 may be used to stop the advancement of the hand tool that is slide upon the guide track 810.

FIGS. 24b-24c are perspective views of a second stop 850 and third stop 860 comprising a slide bar 1074 and a connector 660 operable to be coupled to the central channel of the SMEs 610, in accordance with an embodiment. The gap formed between the two modified connectors 1074, as shown in FIG. 25, provides, among other things, a substantially zero clearance support for the saw blade therebetween, as shown in FIG. 26a.

The leading edges of the first and second stops 850, 860 provide a fence or support to rest a workpiece against during working, as shown in FIG. 26b. The set screw 853 may be loosened to adjust the gap between the two modified connectors 1074, or to move them out of the way entirely.

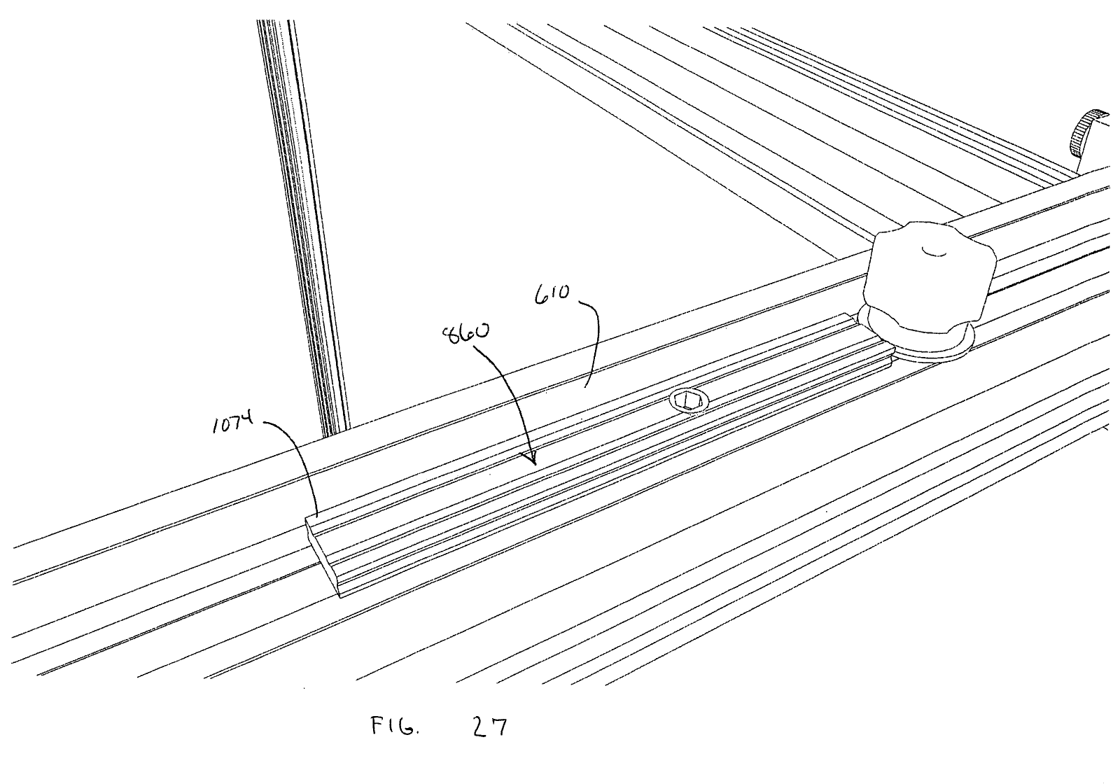

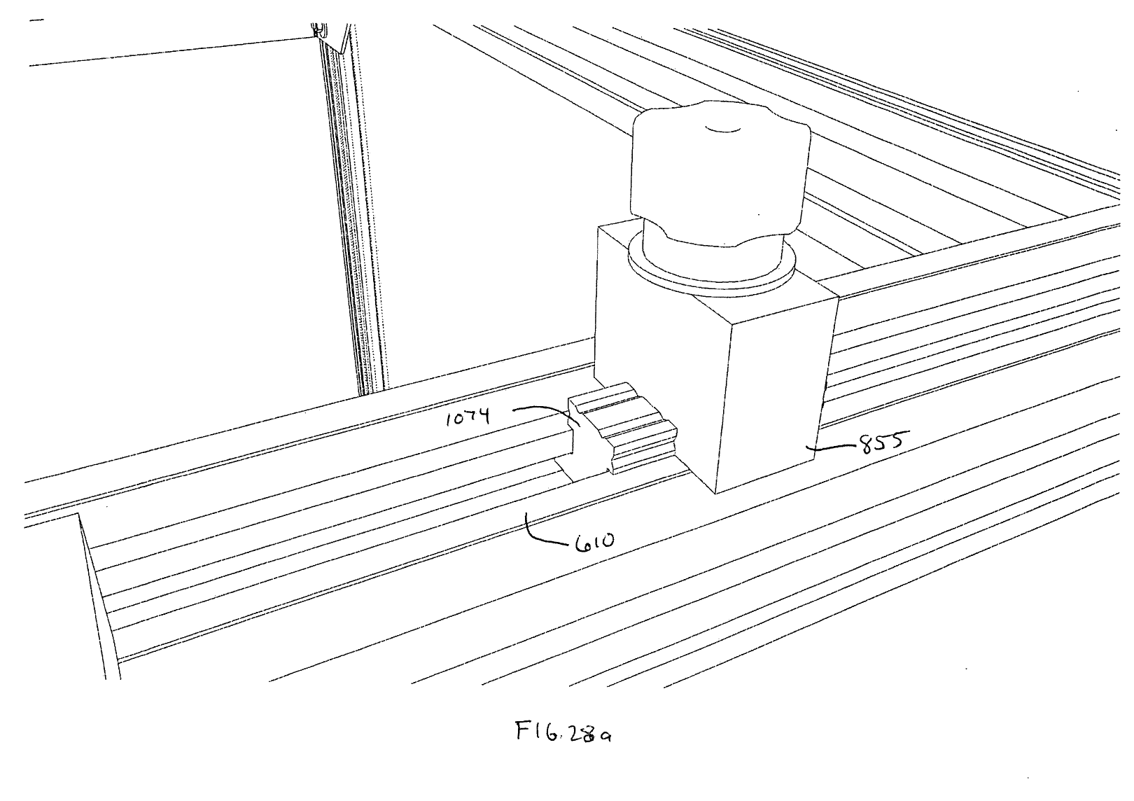

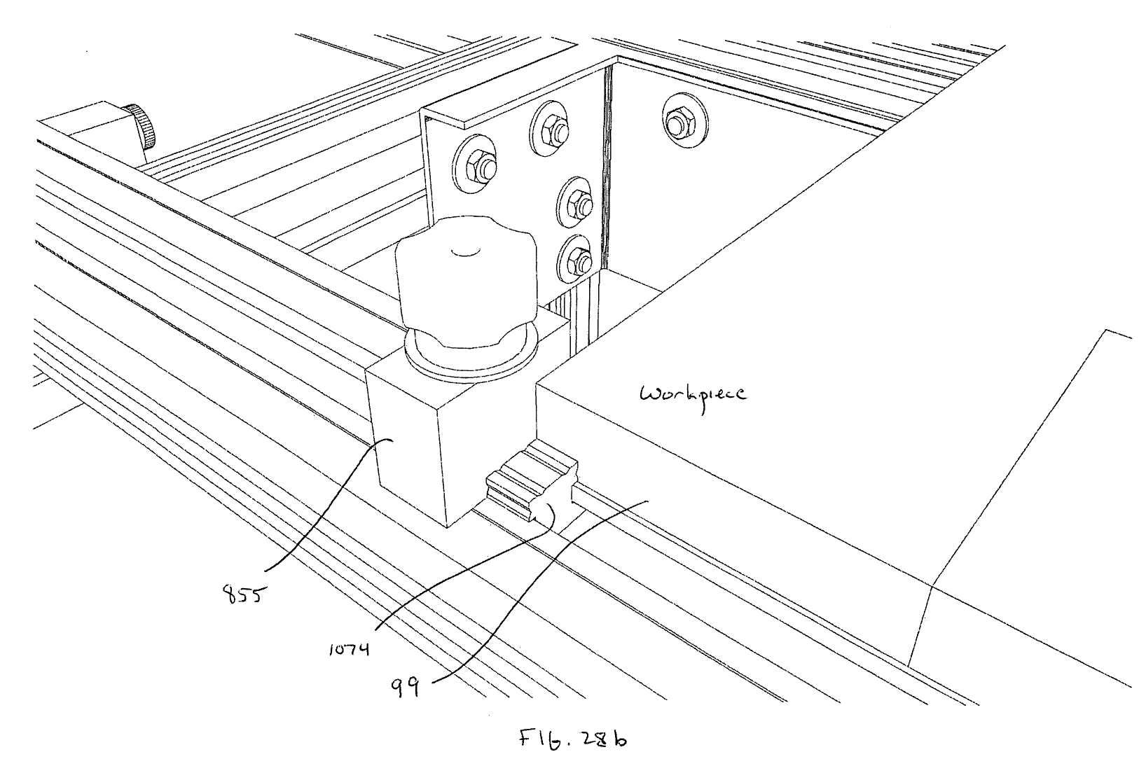

FIG. 27 is a perspective view of the second stop 860 as coupled to a SME 610, in accordance with an embodiment.

FIG. 27 is a perspective view of the third stop 870 as coupled to a SME 610, in accordance with an embodiment.

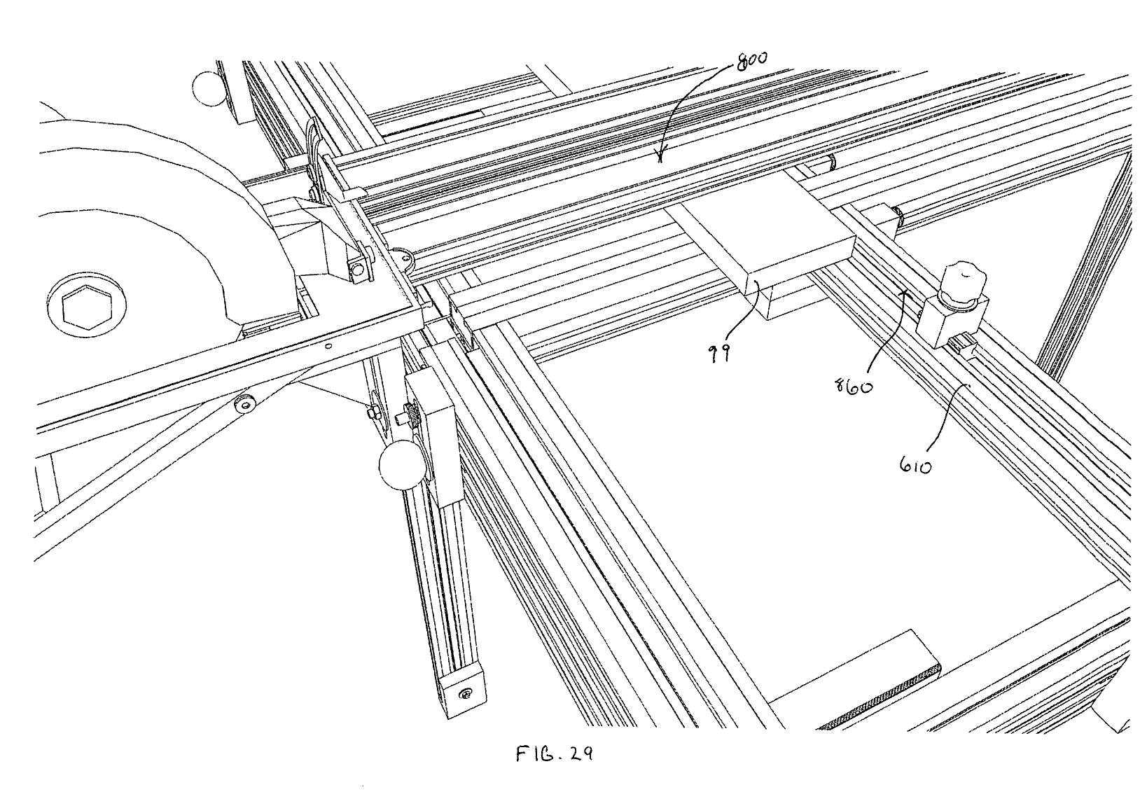

FIG. 28a is a perspective view of the slide bar stop 855 as coupled to a SME 610, in accordance with an embodiment. FIG. 28b is a perspective view of the slide bar stop 855 as coupled to a SME 610 and used as a squaring stop to support a workpiece 99 on two sides, in accordance with an embodiment.

FIG. 29 is a perspective view of the third stop 860 as coupled to a SME 610, in accordance with an embodiment. The third stop 860 is used as a stop to support the workpiece 99 on one side as the bridge assembly 900 supports the workpiece 99 from the top. A second stop 860 that is hidden from view by the bridge assembly 800 supports the same side of the workpiece as the third stop 860.

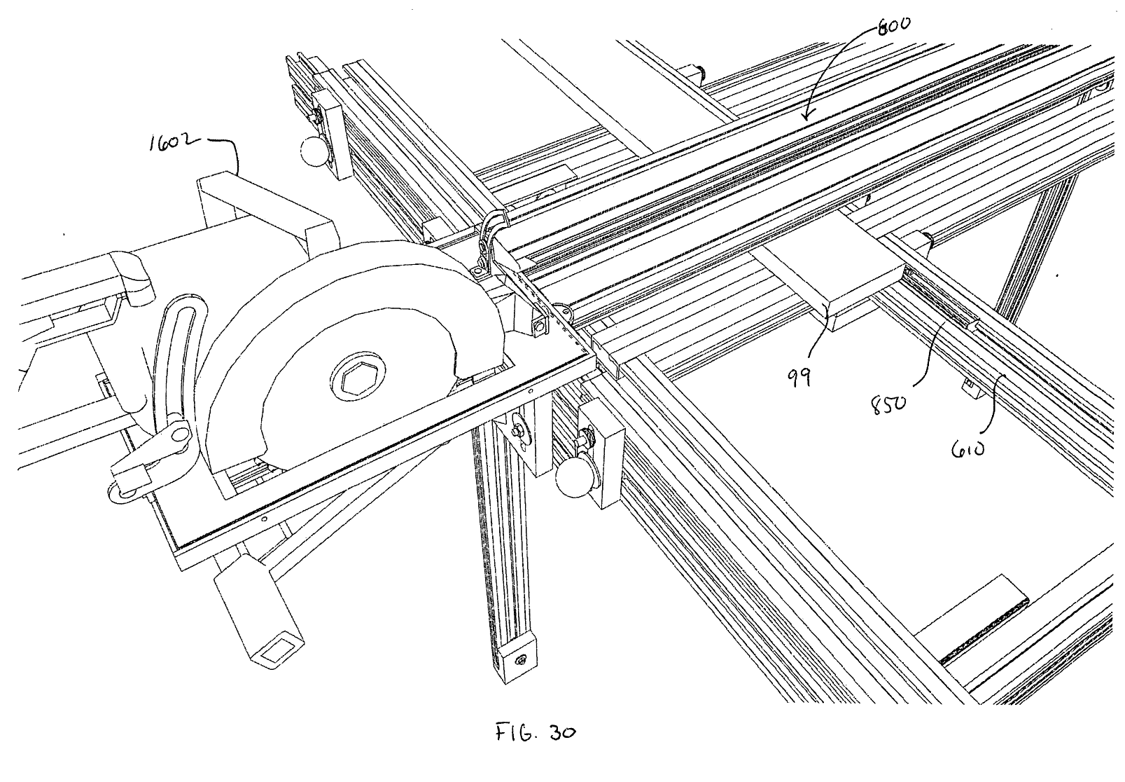

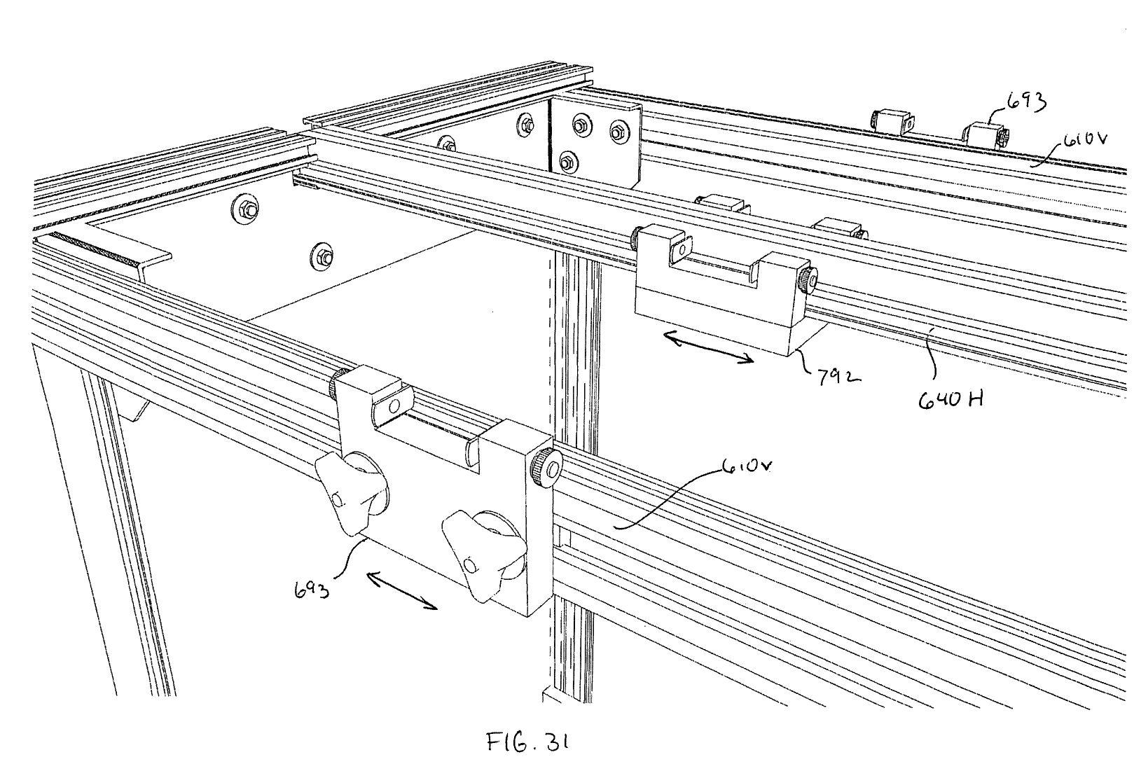

FIG. 30 is a perspective view of the second stop 850 as coupled to a SME 610, in accordance with an embodiment. The second stop 850 is used as a stop to support the workpiece 99 on one side as the bridge assembly 900 supports the workpiece 99 from the top. Another second stop 860 that is hidden from view by the bridge assembly 800 supports the same side of the workpiece as the second stop 860.

FIG. 31 is a perspective view of the top of the frame 600 and central SSME 640h with the sliding brackets 693 and 792 shown without a connecting SME 610, in accordance with an embodiment. The sliding brackets 693, 792 are operable to advance along a SME 610 to provide a support that may be repositioned at any location along the SME 610; the first sliding bracket 693 sliding along a vertical SME 610v and the second sliding bracket 792 sliding along a frame SSME as a horizontal SSME 640h.

Bridge

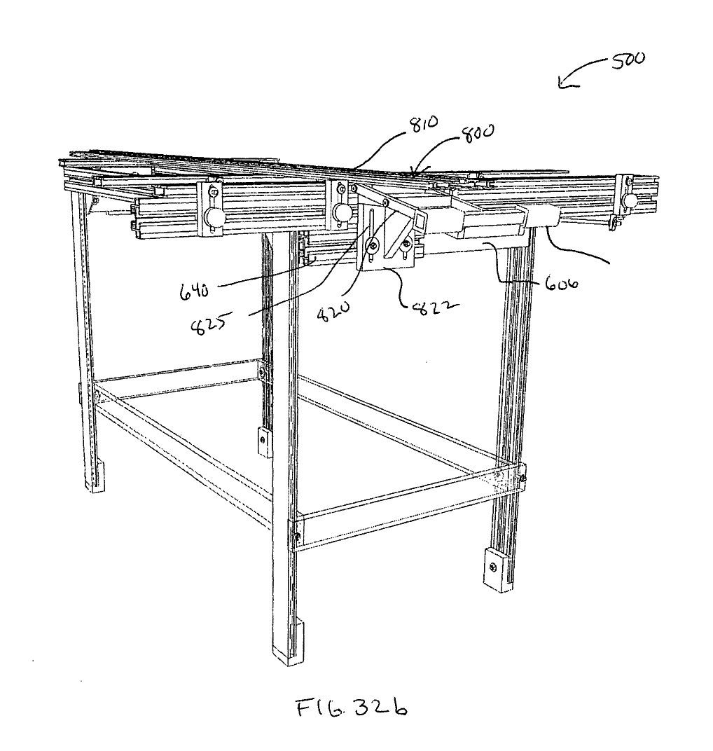

FIGS. 32a and 32b are perspective views of the bridge assembly 800, in the up position and the down position, respectively, as coupled to the frame 600. The bridge assembly 800 comprises a guide rail 810, bridge arms 820 pivotally coupled to the guide rail 810, bridge bracket 822 pivotally coupled to the bridge arms 820. A lower SSME 640 is coupled to each frame connector 606, parallel to the frame SSME 610. The bridge bracket 822 may be raised and lowered via two slots 825 through which fasteners pass. A precise height adjustment may be affected. A tool, such as circular saw 1602, may be guided along the guide rail 810 as shown in FIG. 30. Although the bridge assembly 800 may be coupled to the frame SSME, it may be desired to slide the frame SSME left and right to extend the frame 600 to accommodate longer lengths of workpiece. Therefore with the bridge assembly 800 coupled to the lower SSME provides that the frame SSME remains free to slide when desired.

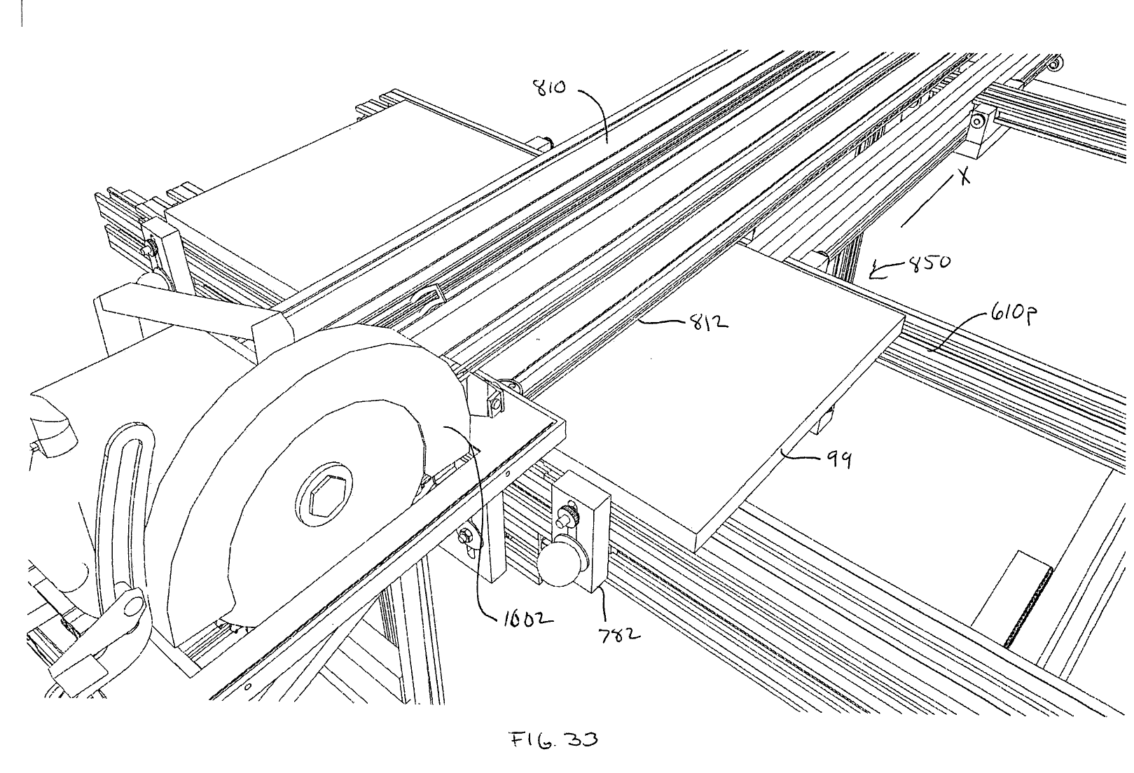

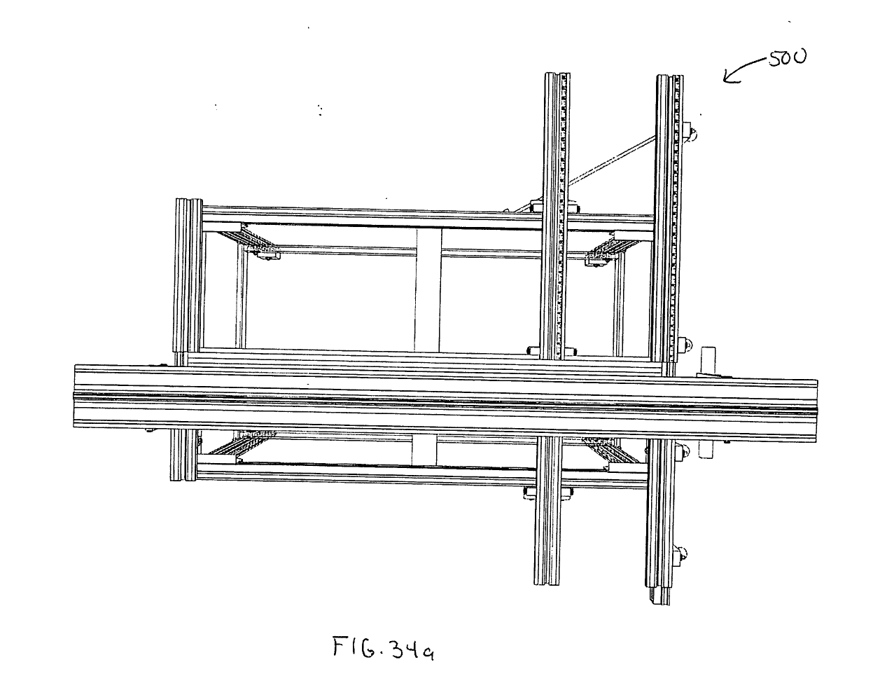

FIG. 33 is a top perspective view of a workpiece 99 engaged with the guide table 500, in accordance with an embodiment. The workpiece 99 is about to be cross-cut along the edge 812 of the guide rail 810. The guide rail 810 is configured as a bridge assembly 800 that may be raised to place the workpiece 99 and lowered onto the workpiece 99 which provides a degree of clamping pressure on the workpiece 99. The workpiece abuts sliding stops 850 (out of view) so as to prevent movement in the X axis. The perpendicular SME 610p with the stop 850 performs the function of a sliding fence.

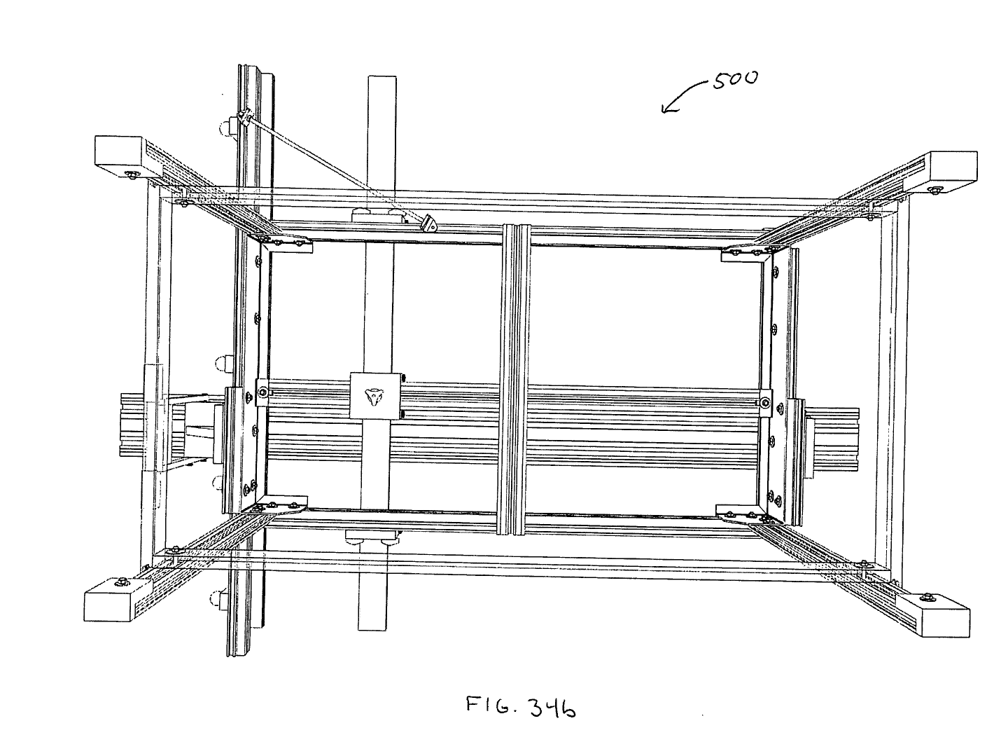

FIGS. 34a and 34b are top and bottom views, respectively, of the guide table 500, in accordance with an embodiment.

The guide table is operable such that a workpiece may be easily secured thereto.

In accordance with embodiments, the guide table includes an integrated measurement system for repeatable and accurate cutting, grooving, drilling and the like with a tool without using a tape measure or marking the surface of the material.

In accordance with embodiments, the guide table is operable to allow for accurate and easy positioning to the workpiece, wherein the cutting line on the workpiece is defined at the outer side edge of the guide track. This eliminates the need for any off-set measurements or add-on elements for measurements or the time consuming labor required for doing such measurements.

In accordance with embodiments, the guide table provides a versatile positioning system, such that the guide tracking channels can be in a center position or in off-center positions in order to make it easier to connect to multiple tools without the need for large extension arms. The guide table allows for the guide track to function using either of its working surfaces and its edge tracking channels for multiple tools, such as, but not limited to, circular saws, jig saws, routers, belt sanders and planers, as well as other tools, such as a cut-off saw, a grinder, a drill, a sliding square, a sliding level, a tile layout guide and the like.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

I claim:

1. Apparatus with the inventive features shown and described.

2. Methods with the inventive features shown and described.
